(19) United States
(12) Patent Application Publication
(10) Pub. No.: US 2023/0319267 A1
(43) Pub. Date: Oct. 5, 2023

(54) VIDEO CODING METHOD AND VIDEO DECODER

(71) Applicant: GUANGDONG OPPO MOBILE TELECOMMUNICATIONS CORP., LTD., Dongguan (CN)

(72) Inventor: Fan WANG, Dongguan (CN)

(21) Appl. No.: 18/327,571

(22) Filed: Jun. 1, 2023

Related U.S. Application Data
(63) Continuation of application No. PCT/CN2020/133677, filed on Dec. 3, 2020.

(51) Int. Cl. H04N 19/11; H04N 19/176; H04N 19/593; H04N 19/70

(52) U.S. Cl. CPC H04N 19/11; H04N 19/176; H04N 19/593; H04N 19/70

(57) ABSTRACT

A video coding method and system, a video encoder, and a video decoder is provided in the disclosure. When an initial intra prediction mode of a first component of a current block is determined as a derivation mode, at least two intra prediction modes of a second component corresponding to the current block are obtained. The intra prediction mode of the first component of the current block of the first component of the current block is determined according to the at least two intra prediction modes of the second component. Intra prediction is performed on the first component of the current block by using the intra prediction mode of the first component of the current block.

### CROSS-REFERENCE TO RELATED APPLICATION(S)

This application is a continuation of International Application No. PCT/CN2020/133677, filed Dec. 3, 2020, the entire disclosure of which is incorporated herein by reference.

### TECHNICAL FIELD

This disclosure relates to the field of video coding, and in particular to a video coding method and system, a video encoder, and a video decoder.

### BACKGROUND

Digital video technologies can be incorporated into a variety of video devices, such as digital televisions, smartphones, computers, e-readers, or video players, etc. With the development of video technologies, the amount of video data is relatively large. In order to facilitate transmission of the video data, a video device implement a video compression technology to enable more effective transmission or storage of the video data.

At present, redundant information in video data is reduced or removed by spatial prediction or temporal prediction, so as to realize compression of the video data. Prediction methods include inter prediction and intra prediction. In intra prediction, a current block is predicted based on an adjacent block(s) which is already decoded in a same picture.

When the current block is predicted, usually a luma component and a chroma component of the current block are predicted respectively to obtain a corresponding luma prediction block and/or a chroma prediction block. A correlation between the luma component and the chroma component is not well utilized, such that the chroma component cannot be predicted simply and efficiently.

### SUMMARY

In a first aspect, a video encoding method is provided. The method includes the following. A current block is obtained, where the current block includes a first component. An initial intra prediction mode of the first component of the current block is determined. When the initial intra prediction mode is a derivation mode, at least two intra prediction modes of a second component corresponding to the current block are obtained. An intra prediction mode of the first component of the current block is determined according to the at least two intra prediction modes of the second component. A final prediction block of the first component of the current block is obtained by performing intra prediction on the first component of the current block using the intra prediction mode of the first component of the current block.

In a second aspect, a video decoding method is provided. The method includes the following. A bitstream is parsed to obtain a current block and at least two intra prediction modes of a second component corresponding to the current block, where the current block includes a first component. An initial intra prediction mode of the first component of the current block is determined. When the initial intra prediction mode is determined as a derivation mode, an intra prediction mode of the first component of the current block is determined according to the at least two intra prediction modes of the second component. A final prediction block of the first component of the current block is obtained by performing intra prediction on the first component of the current block using the intra prediction mode of the first component of the current block.

In a third aspect, a video decoder is provided. The video decoder includes a processor and a memory for storing a computer program. The processor is configured to invoke and run the computer program stored in the memory to perform the method of the second aspect and implementations thereof.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is a schematic block diagram of a video coding system 100 in implementations of the disclosure.

FIG. 2 is schematic block diagram of a video encoder 200 provided in implementations of the disclosure.

FIG. 3 is schematic block diagram of a decoding framework 300 provided in implementations of the disclosure.

FIG. 4A illustrates weight maps of 64 modes in a geometric partitioning mode (GPM) for a square block.

FIG. 4B illustrates weight maps of 54 modes in angular weighted prediction (AWP) for a square block.

FIG. 5 is a schematic diagram illustrating reference pixels in implementations of the disclosure.

FIG. 6 is a schematic diagram illustrating a multiple-reference-line (MRL) intra prediction method in implementations of the disclosure.

FIG. 7 is a schematic diagram illustrating 9 intra prediction modes in H.264.

FIG. 8 is a schematic diagram illustrating 35 intra prediction modes in HEVC.

FIG. 9 is a schematic diagram illustrating 67 intra prediction modes in VVC.

FIG. 10 is a schematic diagram illustrating 66 intra prediction modes in AVS3.

FIG. 11A is a schematic diagram illustrating a principle of intra prediction of a luma block in implementations of the disclosure.

FIG. 11B is a schematic diagram illustrating a method for storing intra prediction modes in implementations of the disclosure.

FIG. 12 is a schematic flowchart of a video encoding method 400 provided in implementations of the disclosure.

FIG. 13 is a schematic diagram illustrating division of a first component and a second component in implementations of the disclosure.

FIG. 14 is another schematic flowchart of a video encoding method 500 provided in implementations of the disclosure.

FIG. 15 is another schematic flowchart of a video encoding method 600 provided in implementations of the disclosure.

FIG. 16 is a schematic flowchart of a video decoding method 700 provided in implementations of the disclosure.

FIG. 17 is a schematic flowchart of a video decoding method 800 provided in implementations of the disclosure.

FIG. 18 is a schematic flowchart of a video decoding method 900 provided in implementations of the disclosure.

FIG. 19 is a schematic block diagram of a video encoder 10 provided in implementations of the disclosure.

FIG. 20 is a schematic block diagram of a video decoder 20 provided in implementations of the disclosure.

FIG. 21 is a schematic block diagram of an electronic device 30 provided in implementations of the disclosure.

FIG. 22 is a schematic block diagram of a video coding system 40 provided in implementations of the disclosure.

### DETAILED DESCRIPTION

The disclosure can be applied to the field of picture coding, video coding, hardware video coding, dedicated circuit video coding, real-time video coding, etc. For example, the solution in the disclosure may be incorporated into audio video coding standards (AVS), such as H.264/audio video coding (AVC) standard, H.265/high efficiency video coding (HEVC) standard, and H.266/versatile video coding (VVC) standard. Alternatively, the solution in the disclosure may incorporated into other proprietary or industry standards, including ITU-TH.261, ISO/IECMPEG-1Visual, ITU-TH.262 or ISO/IECMPEG-2Visual, ITU-TH.263, ISO/IECMPEG-4Visual, ITU-TH.264 (also known as ISO/IECMPEG-4AVC), including scalable video coding (SVC) and multi-view video coding (MVC) extensions. It should be understood that the techniques in the disclosure are not limited to any particular coding standard or technology.

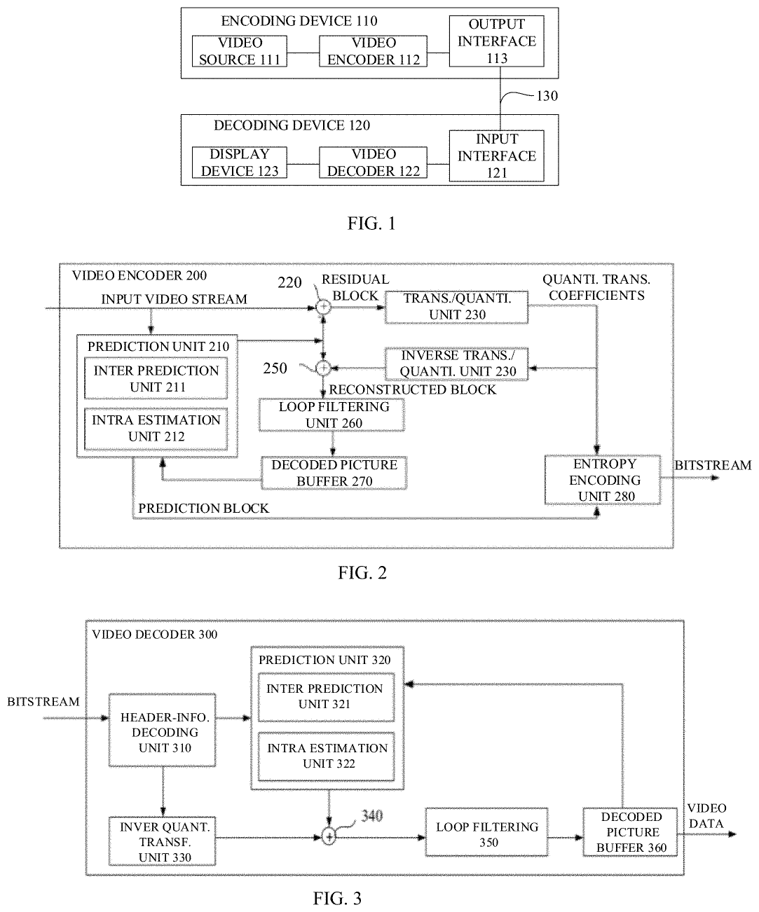

For ease of understanding, a video coding system in implementations of the disclosure is first introduced with reference to FIG. 1.

FIG. 1 is a schematic block diagram of a video coding system 100 according to implementations of the disclosure. It should be noted that FIG. 1 is only an example, and the video coding system in implementations of the disclosure includes but is not limited to what is illustrated in FIG. 1. As illustrated in FIG. 1, the video coding system 100 includes an encoding device 110 and a decoding device 120. The encoding device is configured to encode (which can be understood as compress) video data to generate a bitstream, and transmit the bitstream to the decoding device. The decoding device decodes the bitstream generated by the encoding device to obtain decoded video data.

The encoding device 110 in the implementations of the present disclosure can be understood as a device having a video encoding function, and the decoding device 120 can be understood as a device having a video decoding function, that is, the encoding device 110 and the decoding device 120 in the implementations of the present disclosure include a wider range of devices, including smartphones, desktop computers, mobile computing devices, notebook (such as laptop) computers, tablet computers, set-top boxes, televisions, cameras, display devices, digital media players, video game consoles, vehicle-mounted computers, and the like.

In some implementations, the encoding device 110 may transmit encoded video data (such as bitstream) to the decoding device 120 via a channel 130. The channel 130 may include one or more media and/or apparatuses capable of transferring the encoded video data from the encoding device 110 to the decoding device 120.

In an example, channel 130 includes one or more communication media that enable the encoding device 110 to transmit the encoded video data directly to the decoding device 120 in real-time. In this example, the encoding device 110 may modulate the encoded video data according to a communication standard and transmit the modulated video data to the decoding device 120. The communication medium includes a wireless communication medium, such as a radio frequency spectrum. Optionally, the communication medium may also include a wired communication medium, such as one or more physical transmission lines.

In another example, the channel 130 includes a storage medium that can store video data encoded by the encoding device 110. The storage medium includes a variety of local access data storage media, such as optical discs, DVDs, flash memory, and the like. In this example, the decoding device 120 may obtain encoded video data from the storage medium.

In another example, the channel 130 may include a storage server that may store video data encoded by the encoding device 110. In this example, the decoding device 120 may download the stored encoded video data from the storage server. Optionally, the storage server may store the encoded video data and may transmit the encoded video data to the decoding device 120. For example, the storage server may be a web server (e.g., for a web site), a file transfer protocol (FTP) server, and the like.

In some implementations, the encoding device 110 includes a video encoder 112 and an output interface 113. The output interface 113 may include a modulator/demodulator (modem) and/or a transmitter.

In some implementations, the encoding device 110 may include a video source 111 in addition to the video encoder 112 and the input interface 113.

The video source 111 may include at least one of a video capture apparatus (for example, a video camera), a video archive, a video input interface, or a computer graphics system, where the video input interface is configured to receive video data from a video content provider, and the computer graphics system is configured to generate video data.

The video encoder 112 encodes the video data from the video source 111 to generate a bitstream. The video data may include one or more pictures or a sequence of pictures. The bitstream contains encoding information of a picture or a sequence of pictures. The encoding information may include encoded picture data and associated data. The associated data may include a sequence parameter set (SPS), a picture parameter set (PPS), and other syntax structures. The SPS may contain parameters applied to one or more sequences. The PPS may contain parameters applied to one or more pictures. The syntax structure refers to a set of zero or multiple syntax elements arranged in a specified order in the bitstream.

The video encoder 112 directly transmits the encoded video data to the decoding device 120 via the output interface 113. The encoded video data may also be stored on a storage medium or a storage server for subsequent reading by the decoding device 120.

In some implementations, the decoding device 120 includes an input interface 121 and a video decoder 122.

In some implementations, the decoding device 120 may include a display device 123 in addition to the input interface 121 and the video decoder 122.

The input interface 121 includes a receiver and/or a modem. The input interface 121 may receive encoded video data through the channel 130.

The video decoder 122 is configured to decode the encoded video data to obtain decoded video data, and transmit the decoded video data to the display device 123.

The display device 123 displays the decoded video data. The display device 123 may be integrated with the decoding device 120 or external to the decoding device 120. The display device 123 may include various display devices, such as a liquid crystal display (LCD), a plasma display, an organic light emitting diode (OLED) display, or other types of display devices.

In addition, FIG. 1 is only an example, and the technical solutions of the implementations of the present disclosure are not limited to FIG. 1. For example, the technology of the present disclosure may also be applied to one-sided video encoding or one-sided video decoding.

In the following, a video encoding framework in implementations of the disclosure will be introduced.

FIG. 2 is a schematic block diagram of a video encoder 200 provided in implementations of the present disclosure. It should be understood that the video encoder 200 may be configured to perform lossy compression or lossless compression on a picture. The lossless compression may be visually lossless compression or mathematically lossless compression.

The video encoder 200 may be applied to picture data in luma-chroma (YCbCr, YUV) format. For example, a YUV ratio can be 4:2:0, 4:2:2 or 4:4:4, where Y represents luminance (Luma), Cb (U) represents blue chrominance, and Cr (V) represents red chrominance. U and V represent chrominance (Chroma) for describing color and saturation. For example, in terms of color format, 4:2:0 represents that every 4 pixels have 4 luma components and 2 chroma components (YYYYCbCr), 4:2:2 represents that every 4 pixels have 4 luma components and 4 chroma component (YYYYCbCrCbCr), and 4:4:4 represents full pixel display (YYYYCbCrCbCrCbCrCbCr).

For example, the video encoder 200 reads video data, and for each picture in the video data, divides the picture into several coding tree units (CTU). In some examples, the CTU may be called “tree block”, “largest coding unit” (LCU), or “coding tree block” (CTB). Each CTU may be associated with a pixel block of the same size as the CTU within the picture. Each pixel may correspond to one luminance (luma) sample and two chrominance (chroma) samples. Thus, each CTU may be associated with one luma sample block and two chroma sample blocks. The CTU may have a size of 128×128, 64×64, 32×32, and so on. The CTU may be further divided into several coding units (CUs) for coding. The CU may be a rectangular block or a square block. The CU may be further divided into a prediction unit (PU) and a transform unit (TU), so that coding, prediction, and transformation are separated, and thus processing is more flexible. In an example, the CTU is divided into CUs in a quadtree manner, and the CU is divided into TUs and PUs in a quadtree manner.

The video encoder and video decoder can support various PU sizes. Assuming that a size of a specific CU is 2N×2N, video encoders and video decoders may support PUs of 2N×2N or N×N for intra prediction, and support symmetric PUs of 2N×2N, 2N×N, N×2N, N×N, or similar size for inter prediction. The video encoder and video decoder may also support asymmetric PUs of 2N×nU, 2N×nD, nL×2N, or nR×2N for inter prediction.

In some implementations, as illustrated in FIG. 2, the video encoder 200 may include a prediction unit 210, a residual unit 220, a transform/quantization unit 230, an inverse transform/quantization unit 240, a reconstruction unit 250, a loop filtering unit 260, a decoded picture buffer 270, and an entropy encoding unit 280. It should be noted that the video encoder 200 may include more, less, or different functional components.

Optionally, in this disclosure, a current block may be referred to as a current CU or a current PU. A prediction block may be referred to as a predicted picture block or a picture predicted block, A reconstructed picture block may be referred to as a reconstructed block or a picture reconstructed block.

In some implementations, the prediction unit 210 includes an inter prediction unit 211 and an intra estimation unit 212. Since there is a strong correlation between adjacent pixels in a video picture, intra prediction is used in the video coding technology to eliminate spatial redundancy between adjacent pixels. Since there is a strong similarity between adjacent pictures in video, inter prediction is used in the video coding technology to eliminate temporal redundancy between adjacent pictures, thereby improving coding efficiency.

The inter prediction unit 211 may be used for inter prediction. The inter prediction can refer to picture information of different pictures. In inter prediction, motion information is used to find a reference block from a reference picture, and a prediction block is generated according to the reference block to eliminate temporal redundancy. A picture for which inter prediction is used may be a P frame and/or a B frame, where P frame refers to a forward predicted picture, and B frame refers to bidirectional predicted picture. The motion information includes a reference picture list containing the reference picture, a reference picture index, and a motion vector. The motion vector can be a full-pixel motion vector or a sub-pixel motion vector. If the motion vector is the sub-pixel motion vector, interpolation filtering on the reference picture is required to generate a required sub-pixel block. Here, a block of full pixels or sub-pixels found in the reference picture according to the motion vector is called a reference block. In some technologies, the reference block may be called a prediction block, and in some technologies the prediction block will be generated based on the reference block. Generating the prediction block based on the reference block may also be understood as taking the reference block as a prediction block and then processing and generating a new prediction block based on the prediction block.

Currently the most commonly used inter prediction methods include geometric partitioning mode (GPM) in the VVC video coding standard, and angular weighted prediction (AWP) in the AVS3 video coding standard. These two intra prediction modes have something in common in principle.

In traditional unidirectional prediction, only a reference block with the same size as the current block is found. In traditional bidirectional prediction, two reference blocks with the same size as the current block are found, and a value of each pixel of the prediction block is an average of values at corresponding locations in the two reference blocks, that is, all points of each reference block contribute 50% to the prediction block. Bidirectional weighted prediction may make contributions of the two reference blocks different, for example, all points in a first reference block contribute 75%, and all points in a second reference block contribute 25%, where all points in the same reference block have the same contribution. In GPM or AWP, similarly, two reference blocks with the same size as the current block are used, but for some pixel locations, 100% of pixel values at corresponding locations of a first reference block are used, and for some pixel locations, 100% of pixel values at the corresponding locations of a second reference block are used. For a transition area, pixel values at the corresponding locations of the two reference blocks are used according to a certain ratio. Weights of the pixel values may be determined by a mode of GPM or AWP. It can also be considered that in GPM or AWP, two reference blocks with different sizes from the current block are used, that is, each reference block takes a required part of the current block. That is, a part with non-zero weight(s) is used as a reference block, and a part with zero weight(s) is eliminated.

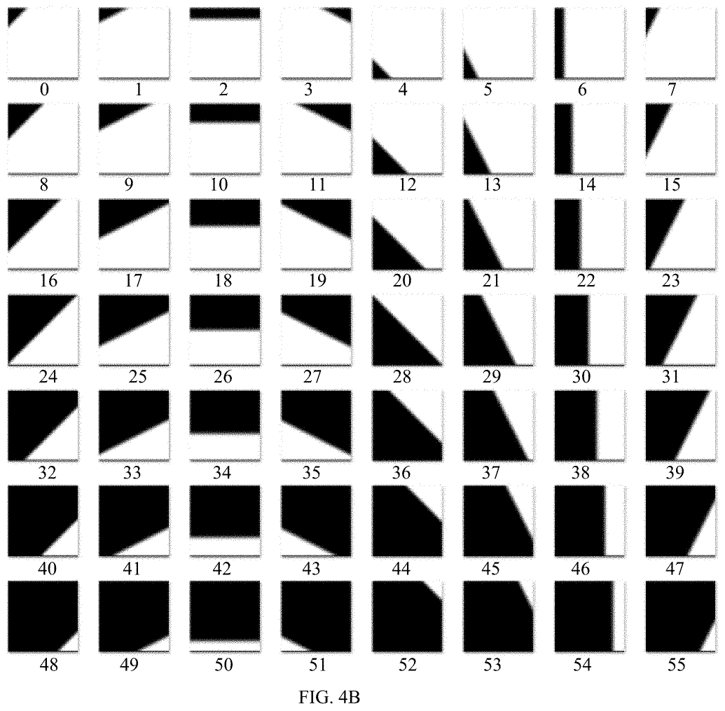

FIG. 4A illustrates weight maps of 64 modes of in GPM for a square block, where black indicates that a weight value of a corresponding location in the first reference block is 0%, white indicates that a weight value of a corresponding location in the first reference block is 100%, and a gray area indicates that weight values of corresponding locations in the first reference block are greater than 0% and less than 100%, depending on the shade of the color. A weight value of a location in the second reference block is 100% minus a weight value of the corresponding location in the first reference block.

FIG. 4B illustrates weight maps of 56 modes in AWP for a square block, where black indicates that a weight value of a corresponding location in the first reference block is 0%, white indicates that a weight value of a corresponding location in the first reference block is 100%, and a gray area indicates that weight values of corresponding locations in the first reference block are greater than 0% and less than 100%, depending on the shade of the color. A weight value of a location in the second reference block is 100% minus a weight value of the corresponding location in the first reference block.

Weights in GPM and AWP are derived differently. In GPM, an angle and an offset are determined according to each mode, and then a weighting matrix of each mode is calculated. In AWP, a one-dimensional weight line is first generated, and then the one-dimensional weight line are spread across the entire matrix in a manner similar to intra angular prediction.

In an earlier coding technology, there is only a rectangular division method, regardless of division of CU, PU or TU. However, GPM and AWP achieve a non-rectangular division effect for prediction. GPM and AWP use a mask of weights of two reference blocks, that is, the weight map mentioned above. Weights of the two reference blocks for generating a prediction block are determined from the mask, or it can be simply understood as that a part of locations of the prediction block comes from the first reference block and a part of the locations comes from the second reference block, and the transition area (called blending area) is obtained by weighting corresponding locations in the two reference blocks, thus achieving a smoother transition. In GPM and AWP, the current block is not divided into two CUs or PUs according to a dividing line, so the transformation, quantization, inverse transformation, and inverse quantization of the residuals after prediction are also performed on the current block as a whole.

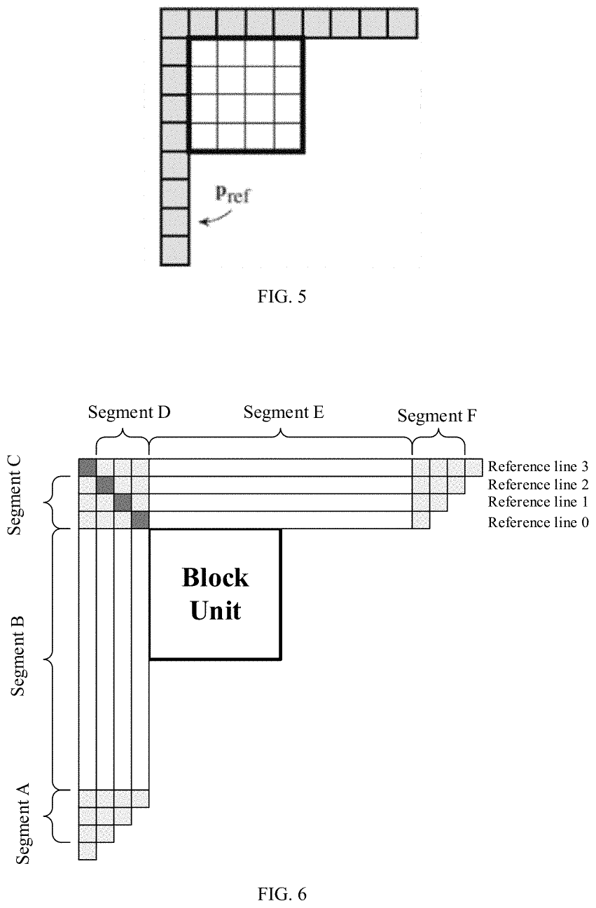

The intra estimation unit 212 predicts pixel information of the current picture block only referring to information of the same picture, so as to eliminate spatial redundancy. I frame is used in intra prediction. For example, as illustrated in FIG. 5, a white 4×4 block is a current block, and gray pixels on the left row and upper column of the current block are reference pixels of the current block. These reference pixels may be used predict the current block in intra prediction. These reference pixels may all be available, that is, all reference pixels have been coded. Some of the reference pixels may be unavailable. For example, the current block is in the leftmost of the whole picture, so the reference pixels on the left of the current block are unavailable. For another example, when the current block is being coded, the lower left part of the current block has not been coded, so the reference pixels at the lower left is also unavailable. For the case where the reference pixels are unavailable, filling may be performed using the available reference pixels or some values, or using some methods, or no filling is performed.

In some implementations, the intra prediction method further includes a multiple reference line (MRL) intra prediction method. As illustrated in FIG. 6, more reference pixels may be used in MRL to improve coding efficiency.

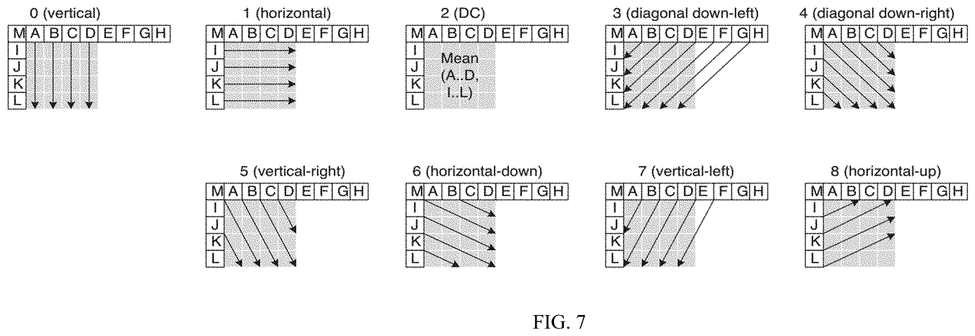

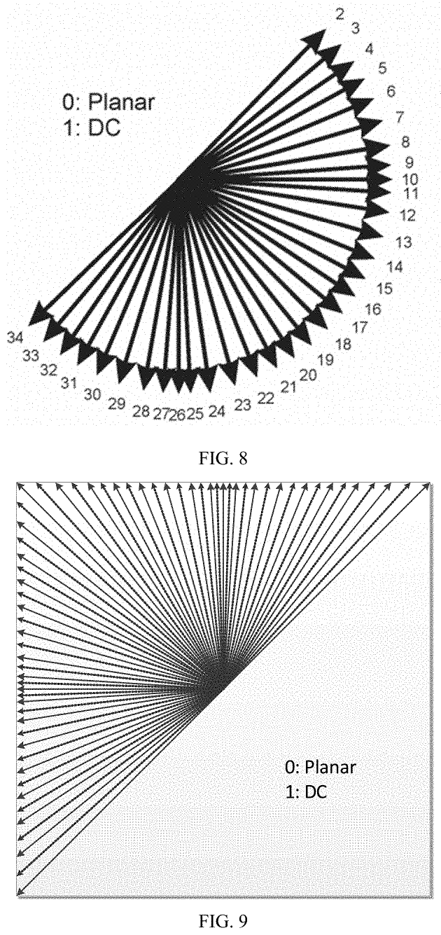

There are multiple prediction modes for intra prediction, as illustrated in FIG. 7, there are 9 modes for performing intra prediction on a 4×4 block in H.264. In mode 0, pixels above the current block are copied to the current block in the vertical direction as prediction values. In mode 1, reference pixels on the left are copied to the current block in the horizontal direction as prediction values. In mode 2 (DC), an average value of 8 pixels A-D and is used as predicted values of all pixels. In modes 3 to 8, reference pixels are copied to corresponding locations of the current block according to a certain angle. Because some locations in the current block cannot exactly correspond to the reference pixels, a weighted average of the reference pixels may be required, or interpolated sub-pixels of the reference pixels may be required.

As illustrated in FIG. 8, intra prediction modes used in HEVC include planar mode (Planar), DC, and 33 angular modes, with a total of 35 prediction modes.

As illustrated in FIG. 9, intra modes used in VVC include Planar, DC, and 65 angular modes, with a total of 67 prediction modes.

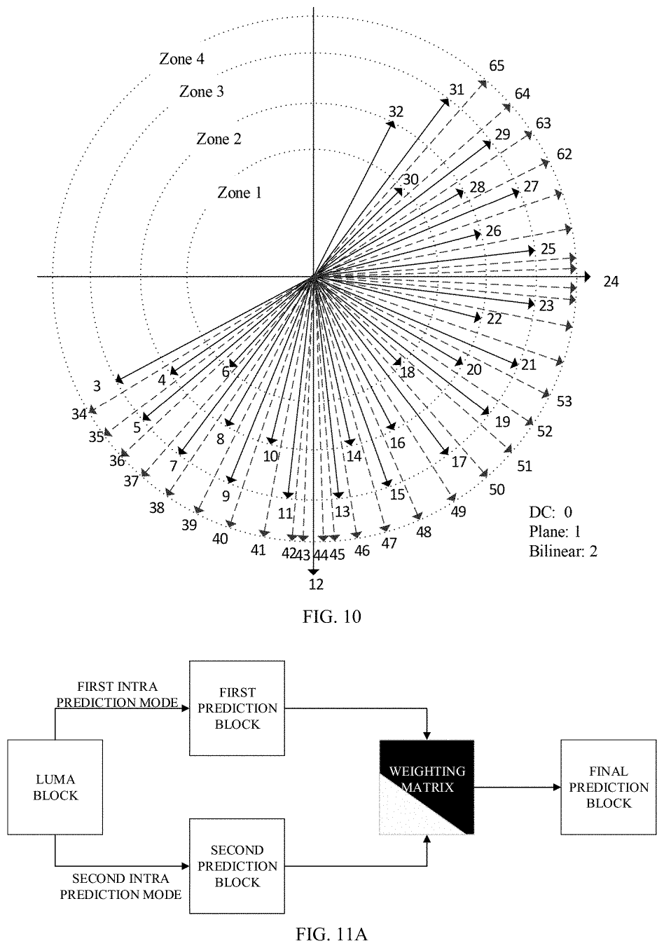

As illustrated in FIG. 10, intra modes used in AVS3 include DC, Plane, Bilinear, and 63 angular modes, with a total of 66 prediction modes.

In some implementations, the intra prediction modes also include some improved modes, such as for improving sub-pixel interpolation of reference pixels, filtering predicted pixels, and the like. For example, for a multiple intra prediction filter (MIPF) in AVS3, different filters may be used for different sized blocks to generate prediction values. Specifically, for pixels at different locations in the same block, one filter is used for a pixel closer to a reference pixel to generate a prediction value, and another filter is used on a pixel farther from the reference pixel to generate a prediction value. For example, for a intra prediction filter (IPF) in AVS3, a prediction value can be filtered using reference pixels.

It should be noted that with the increase of the number of angular modes, the intra prediction will be more accurate, which will be more in line with the demand for the development of high-definition and ultra-high-definition digital video.

The residual unit 220 may generate a residual block of the CU based on a pixel block of the CU and a prediction block of a PU of the CU. For example, the residual unit 220 may generate the residual block for the CU such that each sample in the residual block has a value equal to a difference between a sample in the pixel block of the CU and a corresponding sample in the prediction block of the PU of the CU.

The transform/quantization unit 230 may quantize transform coefficients. The transform/quantization unit 230 may quantize transform coefficients associated with a TU of a CU based on a quantization parameter (QP) value associated with the CU. the video encoder 200 may adjust the degree of quantization applied to transform coefficients associated with the CU by adjusting the QP value associated with the CU.

The inverse transform/quantization unit 240 may perform inverse quantization and inverse transform respectively on the quantized transform coefficients to reconstruct a residual block from the quantized transform coefficients.

The reconstruction unit 250 may add samples in the reconstructed residual block with corresponding samples in one or more prediction blocks generated by the prediction unit 210 to generate a reconstructed picture block associated with the TU. By reconstructing sample blocks of each TU of the CU in this way, the video encoder 200 can reconstruct the pixel block of the CU.

The loop filtering unit 260 may perform deblocking filtering operations to reduce blocking artifacts of the pixel block associated with the CU.

In some implementations, the loop filtering unit 260 includes a deblocking filtering unit and a sample adaptive offset/adaptive loop filtering (SAO/ALF) unit, where the deblocking filtering unit is configured for deblocking, and the SAO/ALF unit is configured to remove a ringing effect.

The decoded picture buffer 270 may store reconstructed pixel blocks. The inter prediction unit 211 may use reference pictures containing reconstructed pixel blocks to perform inter prediction on PUs of other pictures. In addition, the intra estimation unit 212 may use the reconstructed pixel blocks in the decoded picture buffer 270 to perform intra prediction on other PUs in the same picture as the CU.

The entropy encoding unit 280 may receive the quantized transform coefficients from the transform/quantization unit 230. The entropy encoding unit 280 may perform one or more entropy encoding operations on the quantized transform coefficients to generate entropy encoded data.

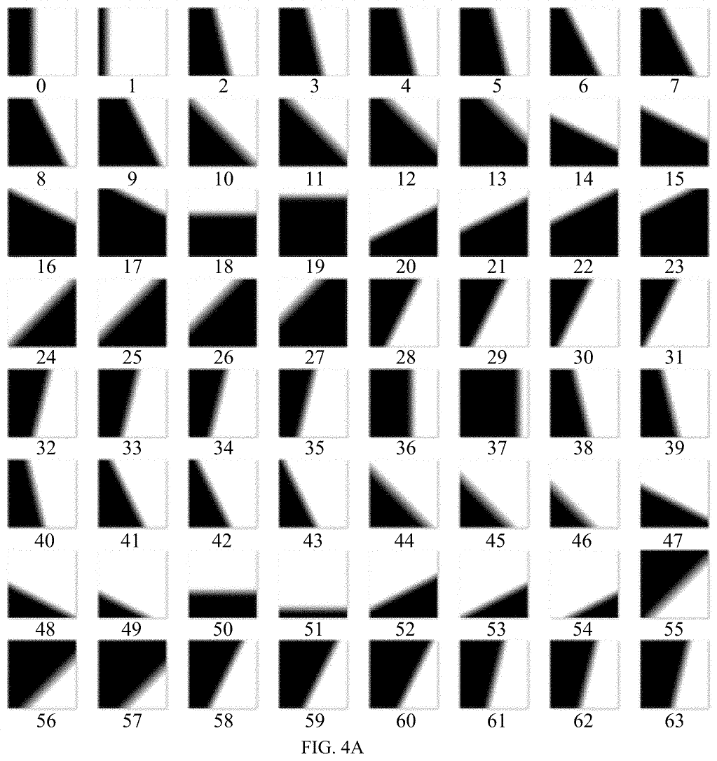

FIG. 3 is a schematic block diagram of a decoding framework 300 provided in implementations of the present disclosure.

As illustrated in FIG. 3, the video decoder 300 includes a header-information decoding unit 310, a prediction unit 320, an inverse quantization transform unit 330, a reconstruction unit 340, a loop filtering unit 350, and a decoded picture buffer 360. It should be noted that the video decoder 300 may include more, less, or different functional components.

The video decoder 300 may receive a bitstream. The header-information decoding unit 310 may parse the bitstream to extract syntax elements from the bitstream. As part of parsing the bitstream, the header-information decoding unit 310 may parse entropy-encoded syntax elements in the bitstream. The prediction unit 320, the inverse quantization transform unit 330, the reconstruction unit 340, and the loop filtering unit 350 may decode video data according to the syntax elements extracted from the bitstream, that is, generate decoded video data.

In some implementations, the prediction unit 320 includes an intra estimation unit 322 and an inter prediction unit 321.

The intra estimation unit 322 may perform intra prediction to generate a prediction block of a PU. The intra estimation unit 322 may use an intra-prediction mode to generate a prediction block of the PU based on a pixel block of spatially neighboring PUs. The intra estimation unit 322 may also determine an intra prediction mode for the PU from one or more syntax elements parsed from the bitstream.

The inter prediction unit 321 can construct a first reference picture list (list 0) and a second reference picture list (list 1) according to the syntax elements parsed from the bitstream. Furthermore, the header-information decoding unit 310 may parse motion information of the PU if the PU is encoded using inter prediction. The inter prediction unit 322 may determine one or more reference blocks for the PU according to the motion information of the PU. The inter prediction unit 321 may generate a prediction block for the PU based on one or more reference blocks of the PU.

The inverse quantization transform unit 330 may perform inverse quantization on (i.e., dequantize) transform coefficients associated with a TU. The inverse quantization transform unit 330 may use a QP value associated with a CU of the TU to determine the degree of quantization.

After inverse quantization of the transform coefficients, the inverse quantization transform unit 330 may perform one or more inverse transformations on the inverse-quantized transform coefficients in order to generate a residual block associated with the TU.

The reconstruction unit 340 uses the residual blocks associated with the TU of the CU and the prediction block of the PU of the CU to reconstruct a pixel block of the CU. For example, the reconstruction unit 340 may add samples in the residual block with corresponding samples in the prediction block to reconstruct the pixel block of the CU to obtain the reconstructed picture block.

The loop filtering unit 350 may perform deblocking filtering to reduce blocking artifacts of the pixel block associated with the CU.

The video decoder 300 may store the reconstructed picture of the CU in decoded picture buffer 360. The video decoder 300 may use the reconstructed picture in the decoded picture buffer 360 as a reference picture for subsequent prediction, or transmit the reconstructed picture to a display device for display.

A basic process of video coding is as follows: at the encoding end, a picture (or frame) is divided into blocks, and for a current block, the prediction unit 210 performs intra prediction or inter prediction to generate a prediction block of the current block. The residual unit 220 may calculate a residual block based on the predicted block and the original block of the current block, that is, a difference between the predicted block and the original block of the current block, where the residual block may also be referred to as residual information. The residual block can be transformed and quantized by the transform/quantization unit 230 to remove information that is not sensitive to human eyes, so as to eliminate visual redundancy. Optionally, the residual block before being transformed and quantized by the transform/quantization unit 230 may be called a time-domain residual block, and the time domain residual block after being transformed and quantized by the transform/quantization unit 230 may be called a frequency residual block or a frequency-domain residual block. The entropy encoding unit 280 receives the quantized transformation coefficients output by the transform/quantization unit 230, and may perform entropy encoding on the quantized transformation coefficients to output a bitstream. For example, the entropy encoding unit 280 can eliminate character redundancy according to the target context model and probability information of the binary bitstream.

At the decoding end, the header-information decoding unit 310 may parse the bitstream to obtain prediction information, a quantization coefficient matrix, etc. of the current block, and the prediction unit 320 performs intra prediction or inter prediction on the current block based on the prediction information to generate a prediction block of the current block. The inverse quantization transform unit 330 uses the quantization coefficient matrix obtained from the bitstream to perform inverse quantization and inverse transformation on the quantization coefficient matrix to obtain a residual block. The reconstruction unit 340 adds the prediction block and the residual block to obtain a reconstructed block. The reconstructed blocks form a reconstructed picture. The loop filtering unit 350 performs loop filtering on the reconstructed picture on a picture basis or on a block basis to obtain a decoded picture. Similar operations for obtaining the decoded picture are also required at the decoding end. The decoded picture may also be referred to as a reconstructed picture, and the reconstructed picture may be a reference picture of a subsequent picture for inter prediction.

It should be noted that block division information determined at the encoding end, as well as mode information or parameter information for prediction, transformation, quantization, entropy coding, and loop filtering, etc., are carried in the bitstream when necessary. The decoding end parses the bitstream and analyzes existing information to determine the block division information, as well as mode information or parameter information for prediction, transformation, quantization, entropy coding, loop filtering, etc. the same as such information at the encoding end, so as to ensure the decoding picture obtained by the encoding end is the same as the decoded picture obtained by the decoding end.

The above is the basic process of video coding under a block-based hybrid coding framework. With the development of technology, some modules or steps of the framework or process may be optimized. This disclosure is applicable to the basic process of the video coding under the block-based hybrid coding framework, but is not limited to the framework and process.

The video encoding system, video encoder, video decoding, and intra prediction modes involved in implementations of the present disclosure are introduced above. On this basis, the technical solutions provided in implementations of the present disclosure will be described in detail below in conjunction with specific implementations.

The video encoder in implementations of the disclosure may be applied to picture blocks in different formats, such as YUV format, YCbCr format, and RGB format. The picture blocks in above formats each include a first component and a second component. For example, for the picture block in YUV format, the second component may be Y component, i.e. luma component, and the first component may be U and/or V component, i.e. chroma component. The second component is more important than the first component. For example, the human eye is more sensitive to luminance than chrominance, so in video coding more interest is taken in the Y component than the U and V components. For example, in some commonly-used YUV formats, a YUV ratio is 4:2:0, in which the number of samples in the U or V component is less than that in the Y component, and a sample ratio of Y, U, and V in a YUV4:2:0 block is 4:1:1. In this case, some coding modes of the chroma component of the picture block may be determined based on information about the coding mode of the luma component.

For picture blocks in other formats, such as RGB format, some coding modes of the first component of the picture block may also be determined based on information about the coding mode of the second component of the picture block. The YUV format is mainly taken as an example in implementations of the disclosure, but the disclosure is not limited to a specific format.

In intra prediction of the second component of the picture block in the disclosure, at least two intra prediction modes of the second component of the picture block are used, so as to achieve accurate prediction for complex textures. For example, the second component is the luma component, and in the disclosure, at least two intra prediction modes are used for predicting a block with complex luma textures, so as to achieve accurate prediction of the block with complex luma textures.

The at least two intra prediction modes of the second component of the picture block include but are not limited to intra prediction modes mentioned above, such as DC, Planar, Plane, Bilinear, and angular prediction modes, and further include an improved prediction mode such as MIPF, IPF, etc.

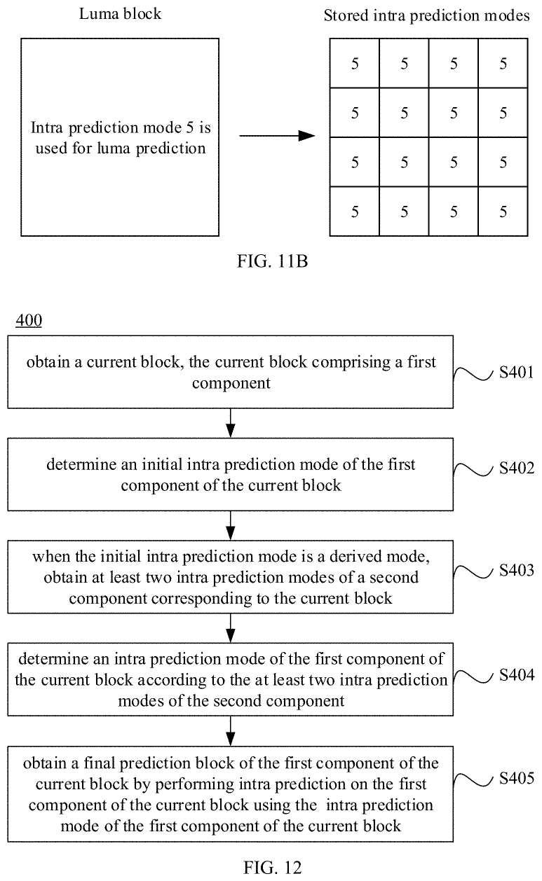

In the intra prediction process on the second component using the at least two intra prediction modes of the second component of the picture block, each of the at least two intra prediction modes is used to predict the second component, so as to obtain prediction blocks corresponding to the intra prediction modes. The prediction blocks corresponding to intra prediction modes are then processed to obtain a final prediction block of the second component of the picture block. For example, the prediction blocks corresponding to the intra prediction modes may be summed up and then averaged to obtain the final prediction block of the second component of the picture block. For example, a weighting matrix is determined, which may be called a second weighting matrix, and the prediction blocks corresponding to intra prediction modes are weighted according to the second weighting matrix to obtain the final prediction block of the second component of the picture block. For example, the second component is a luma component. As illustrated in FIG. 11A, the at least two intra prediction modes of the luma block are a first intra prediction mode and a second intra prediction mode. The first intra prediction mode is used to predict the luma block to obtain a first prediction block, and the second intra prediction mode is used to predict the luma block to obtain a second prediction block. The first prediction block and the second prediction block are weighted using the second weighting matrix to obtain a final prediction block of the luma block.

In an example of the disclosure, different intra prediction modes may also be used for predicting each sample in the second component, to obtain prediction values of each sample corresponding to different intra prediction modes. According to a weight value corresponding to each sample in the second weighting matrix, the prediction values of each sample corresponding to different intra prediction modes are weighted to obtain a final prediction value of each sample in the second component. The final prediction values of all samples in the second component form a final prediction block of the second component of the picture block. In this way, weighting may be performed without waiting for obtaining all prediction blocks, so that additional storage space for storing the first prediction block and the second prediction block can be avoided, thus saving storage resources of the video encoder.

As can be seen, for the same picture block, some coding modes of the first component can be determined according to information of coding modes of the second component. That is, in some cases, the intra prediction mode of the first component of the picture block may be determined according to information of intra prediction modes of the second component of the picture block.

Based on the above, the encoder end will be introduced with reference to FIG. 12 in the following.

FIG. 12 is a schematic flowchart of a video encoding method 400 provided in implementations of the disclosure. The implementations of the disclosure are applied to the video encoder illustrated in FIG. 1 and FIG. 2. As illustrated in FIG. 12, the method in the implementations of the disclosure includes the following.

At S401, a current block is obtained, where the current block includes a first component.

During video encoding, the video encoder receives a video stream that consists of a sequence of pictures. Video encoding is performed on each picture in the video stream. For ease of description, a current picture to-be-encoded is referred to as a target picture. The video encoder divides the target picture into blocks to obtain a current block.

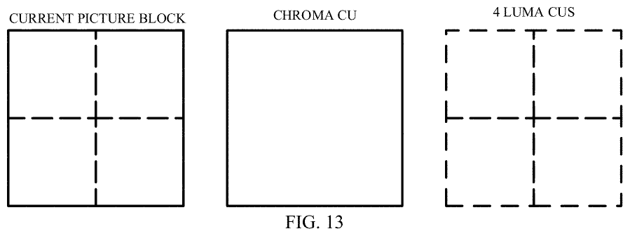

For a traditional division manner, a block after division includes both a first component (such as chroma component) and a second component (such as luma component) at the location of the current block. In comparison, for a separate-tree technology, a block of a separate component can be obtained, such as a separate luma block and a separate chroma block. As illustrated in FIG. 13, a luma block at the same location as a current block (also referred to as current picture block) is divided into 4 luma CUs, while a chroma block is not divided. It can be understood that the luma block includes only a luma component at the location of the current block, and the chroma block includes only a chroma component at the location of the current block. As such, the luma component and the chroma component at the same location may belong to different blocks, which enables better flexibility of division. If the separate-tree is used for CU division, some CUs may include both the first component and the second component, some CUs may include the first component, and others may include only the second component.

In some implementations, the current block includes only the first component. For example, the current block includes only the chroma component, in which case the current block may be understood as a chroma block.

In some implementations, the current block includes both the first and second components. For example, the current block includes both the chroma component and the luma component.

At S402, an initial intra prediction mode of the first component of the current block is determined.

For example, the first component is the chroma component, and the second component is the luma component.

An intra chroma prediction mode may be selected independently or derived according to an intra luma prediction mode of the same block or a co-located or adjacent block. Taking intra chroma prediction modes in AVS3 as an example, Table 1 illustrates multiple modes in intra prediction mode of luma prediction block in AVS3, and Table 2 illustrates multiple modes in intra prediction mode of chroma prediction block in AVS3.

TABLE 1

| IntraLumaPredMode | Intra prediction mode |
|---|---|
| 0 | Intra_Luma_DC |
| 1 | Intra_Luma_Plane |
| 2 | Intra_Luma_Bilinear |
| 3~11 | Intra_Luma_Angular |
| 12 | Intra_Luma_Vertical |
| 13~23 | Intra_Luma_Angular |
| 24 | Intra_Luma_Horizontal |
| 25~32 | Intra_Luma_Angular |
| 33 | Intra_Luma_PCM |
| 34~65 | Intra_Luma_Angular |

In Table 1, IntraLumaPredMode represents a mode number of an intra luma prediction mode, Intra_Luma_DC represents a DC mode for luma intra prediction, Intra_Luma_Plane represents a Plane mode for luma intra prediction, Intra_Luma_Bilinear represents a Bilinear mode for luma intra prediction, Intra_Luma_Vertical represents a vertical mode for luma intra prediction, Intra_Luma_Horizontal represents a horizontal mode for luma intra prediction, Intra_Luma_PCM represents a PCM mode for luma intra prediction, Intra_Luma_Angular represents an angular mode for luma intra prediction.

TABLE 2

| IntraChromaPredMode | Intra prediction mode |
|---|---|
| 0 | Intra_Chroma_DM (value of |
| | IntraLumaPredMode is not equal to 33) |
| 0 | Intra_Chroma_PCM (value of |
| | IntraLumaPredMode is euqal to 33) |
| 1 | Intra_Chroma_DC |
| 2 | Intra_Chroma_Horizontal |
| 3 | Intra_Chroma_Vertical |
| 4 | Intra_Chroma_Bilinear |
| 5 | Intra_Chroma_TSCPM |
| 6 | Intra_Chroma_TSCPM_L |
| 7 | Intra_Chroma_TSCPM_T |
| 8 | Intra_Chroma_PMC |
| 9 | Intra_Chroma_PMC_L |
| 10 | Intra_Chroma_PMC_T |

In Table 2, IntraChromaPredMode represents a mode number of an intra chroma prediction mode, Intra_Chroma_DM represents a DM mode for intra chroma prediction, where the DM mode is a derivation mode, that is, when the DM mode is used as the intra chroma prediction mode, the corresponding intra luma prediction mode is assigned as the intra chroma prediction mode. For example, if the corresponding intra luma prediction mode is an angular mode, the intra chroma prediction mode is also the angular mode. In addition to the DM mode, the intra chroma prediction mode further includes a DC mode (Intra_Chroma_DC), a horizontal mode (Intra_Chroma_Horizontal), a vertical mode (Intra_Chroma_Vertical), a bilinear mode (Bilinear), a PCM mode, a cross-component prediction mode, etc.

The DC mode, Bilinear mode, horizontal mode, and vertical mode corresponding to the chroma component are the same as that corresponding to the luma component. With such mode design, same prediction modes can be used for both chroma intra prediction and luma intra prediction. IntraLumaPredMode equal to 33 represents that the PCM mode is used for the corresponding luma prediction block. If the PCM mode is used for the luma prediction block and IntraChromaPredMode is equal to 0, the PCM mode is also used for intra prediction of the chroma component.

When the video encoder performs intra prediction on the chroma component, the video encoder will try various possible intra prediction modes in Table 2, such as the DM mode, the DC mode (Intra_Chroma_DC), the horizontal mode (Intra_Chroma_Horizontal), the vertical mode (Intra_Chroma_Vertical), the Bilinear mode, the PCM mode, and the cross-component prediction mode (two-step cross-component prediction mode (TSCPM), prediction from multiple cross-components (PMC), cross-component linear model (CCLM) in VVC), etc. The video encoder selects an intra prediction mode with a minimum distortion cost as the initial intra prediction mode of the chroma component of the current block.

If the video encoder determines that the initial intra prediction mode of the chroma component of the current block is not the DM mode but, for example, the DC mode or the vertical mode instead, the video encoder will signal mode information of the determined initial intra prediction mode into a bitstream. A decoder will parse the mode information for the chroma intra prediction to determine the intra chroma prediction mode.

If the video encoder determines that the initial intra prediction mode of the chroma component of the current block is the DM mode, the video encoder will perform operations at S403.

At S403, at least two intra prediction modes of the second component corresponding to the current block are obtained when the initial intra prediction mode is the derivation mode.

The derivation mode indicates that the intra prediction mode of the first component of the current block is derived according to an intra prediction mode of the second component corresponding to the current block. For example, the intra prediction mode of the first component of the current block is the same as the intra prediction mode of the second component, or is determined according to the intra prediction mode of the second component.

In implementations of the disclosure, there are two cases for the second component corresponding to the current block. In a first case, the current block includes both the first component and the second component, where the second component corresponding to the current block refers to the second component included in the current block. In a second case, the current block includes only the first component but no second component, for example, the first component is the chroma component and the current block may be understood as the chroma block. In this case, the current block corresponds to one or more pixels in an original picture to-be-encoded, and a second component corresponding to the one or more pixels is the second component corresponding to the current block.

If the current block includes both the first component and the second component, the intra prediction mode of the second component of the same block may be obtained directly from mode information of the current block. When the intra prediction mode of the second component corresponding to the current block is determined and stored in the mode information of the current block, the at least two intra prediction modes used for intra prediction of the second component corresponding to the current block may be obtained directly from the mode information of the current block.

Mode information of the at least two intra prediction modes used for encoding the second component is stored when the encoder encodes the second component corresponding to the current block. Therefore, if the current block includes the first component but not the second component, the encoder can obtain the stored at least two intra prediction modes of the second component.

The at least two intra prediction modes of the second component are different from each other.

The at least two intra prediction modes used for the second component in intra prediction include but are not limited to the intra prediction modes mentioned above, such as DC, Planar, Plane, Bilinear and angular modes, and further include improved intra prediction modes, such as MIPF, IPF, etc. For ease of description, intra prediction modes such as DC, Planar, Plane, Bilinear, and angular modes are referred to as basic intra prediction modes, and MIPF, IPF, etc. are referred to as improved intra prediction modes. A prediction block can be independently generated using the basic intra prediction mode without depending on other intra prediction modes, that is, the prediction block can be determined once reference samples and the basic intra prediction mode are determined. In comparison, the prediction block cannot be independently generated using the improved intra prediction mode, but also depending on the basic intra prediction mode. For example, the prediction block may be determined and generated using a certain angular prediction mode based on reference samples, while for MIPF, the prediction block is generated or determined based on the angular prediction mode by using different filters for samples at different locations.

In an implementation, all the at least two intra prediction modes of the second component are basic intra prediction modes. That is, in the disclosure, two different basic intra prediction modes, such as a first intra prediction mode and a second intra prediction mode, are used for the second component. Optionally, an improved intra prediction mode may be combined with the first intra prediction mode and the second intra prediction mode respectively. Optionally, after using the at least two basic intra prediction modes to obtain the final prediction block of the second component, the final prediction block may be further improved using the improved intra prediction mode to obtain an updated final prediction block.

In an implementation, the at least two intra prediction modes of the second component are a combination of a basic intra prediction mode and an improved intra prediction mode. For example, the at least two intra prediction modes of the second component are a first intra prediction mode and a second intra prediction mode. The first intra prediction mode is a certain angular intra prediction mode, and the second intra prediction mode is an improved intra prediction mode, such as IPF. Optionally, both the first intra prediction mode and the second intra prediction mode are based on a same angular prediction mode, but the first intra prediction mode is a certain option of the improved intra prediction mode, and the second intra prediction mode is another option of the improved intra prediction mode. Optionally, after the final prediction block of the second component is obtained using the first intra prediction mode and the second intra prediction mode, the final prediction block may be further improved using the improved intra prediction mode to obtain an updated final prediction block.

In an implementation, the at least two intra prediction modes of the second component are a combination of improved intra prediction modes.

At S404, the intra prediction mode of the first component of the current block is determined according the at least two intra prediction modes of the second component.

At S405, a final prediction block of the first component of the current block is obtained by performing intra prediction on the first component of the current block using the intra prediction mode of the first component of the current block.

In some implementations of the disclosure, the intra prediction mode of the first component of the current block includes at least two intra prediction modes. In this case, the manner of determining the intra prediction mode of the first component of the current block according to the at least two intra prediction modes of the second component at S404 includes but is not limited to the following.
Manner 1, the at least two intra prediction modes of the second component are assigned as the intra prediction mode of the first component of the current block. For example, the at least two intra prediction modes of the second component include a first intra prediction mode and a second intra prediction mode, and the first and second intra prediction modes are used as the intra prediction mode of the first component of the current block.
Manner 2, the intra prediction mode of the first component of the current block is derived according to the at least two intra prediction modes of the second component. For example, angles used for the first component have larger gaps than that used for the second component, which means that different intra prediction modes of the second component may lead to a same intra prediction mode of the first component. For example, a horizontal mode of the first component may be derived from a near-horizontal mode (such as an intra prediction mode corresponding to mode number 11 in AVS3) of the second component. Based on the above, at least two intra prediction modes of the first component of the current block are derived according to the at least two intra prediction modes of the second component. For example, a third intra prediction mode of the first component is derived from a first intra prediction mode of the second component, and a fourth intra prediction mode of the first component is derived from a second intra prediction mode of the second component.

When the intra prediction mode of the first component of the current block includes at least two intra prediction modes, operations at S405 include the following.

At S405-A1, for each of the at least two intra prediction modes of the first component of the current block, a prediction block corresponding the intra prediction mode is obtained by performing intra prediction on the first component of the current block using the intra prediction mode.

At S405-A2, the final prediction block of the first component of the current block is obtained according to the prediction blocks corresponding to the intra prediction modes.

For example, the at least two intra prediction modes of the first component of the current block include two intra prediction modes, namely a first intra prediction mode and a second intra prediction mode.

In an implementation, intra prediction is performed on the first component of the current block by using the first intra prediction mode to obtain a first prediction block of the first component of the current block, and intra prediction is performed on the first component of the current block by using the second intra prediction mode to obtain a second prediction block of the first component of the current block. According to a preset operation rule, an operation is performed on the first prediction block and the second prediction block to obtain the final prediction block of the first component of the current block. For example, according to a ratio of 1:1, an average of the first prediction block and the second prediction block is calculated as the final prediction block of the first component of the current block.

In an implementation, for each sample in the first component, the sample is predicted by using the first intra prediction mode obtain a first prediction value of the sample in the first component, and the sample is predicted by using the second intra prediction mode to obtain a second prediction value of the sample in the first component. According to a preset operation rule, an operation is performed on the first prediction value and the second prediction value to obtain a final prediction value of the sample in the first component. For example, an average of the first prediction value and the second prediction value is calculated as the final prediction value of the sample in the first component. The final prediction values of all samples in the first component may be obtained in the same manner, and then form the final prediction block of the first component of the current block.

In an implementation, operations at S405-A2 include operations at S405-A21 and S405-A22.

At S405-A21, a first weighting matrix is determined.

At S405-A22, the final prediction block of the first component of the current block is obtained by weighting the prediction blocks corresponding to the intra prediction modes according to the first weighting matrix.

In the implementation, the final prediction block of the first component of the current block is obtained by determining the first weighting matrix and weighting the prediction blocks corresponding to the intra prediction modes according to the first weighting matrix. For example, the at least two intra prediction modes of the first component of the current block include the first intra prediction mode and the second intra prediction mode. The first intra prediction mode is used to perform intra prediction on the first component of the current block to obtain a first prediction block, and the second intra prediction mode is used to perform intra prediction on the first component of the current block to obtain a second prediction block. For each sample in the first component, a first prediction value of the sample in the first prediction block, a second prediction value of the sample in the second prediction block, and a corresponding weight value in the first weighting matrix are obtained. The first prediction value and the second prediction value are weighted with the weight value to obtain a final prediction value of the sample. The final prediction values of all samples in the first component may be obtained in the same manner, and then form the final prediction block of the first component of the current block.

In a possible implementation, each weight value in the above first weighting matrix is a preset value, for example, each weight value is 1, which means that the weight value corresponding to each intra prediction mode is 1.

In a possible implementation, the first weighting matrix is derived according to the weighting-matrix derivation mode. The weighting-matrix derivation mode can be understood as a mode for deriving a weighting matrix. Each weighting-matrix derivation mode can derive a weighting matrix for a block with a given height and width. Different weighting-matrix derivation modes can derive different weighting matrices for a same block. For example, there are 56 weighting-matrix derivation modes in the AWP of AVS3, and 64 weighting-matrix derivation modes in the GPM of VVC. In this example, according to the weighting-matrix derivation mode, a process of deriving the first weighting matrix is basically the same as that of deriving a second weighting matrix. For example, the second component is the luma component, and the process of deriving the second weighting matrix for the luma component can refer to description of S905, which will not be repeated here. It should be noted that, when deriving the first weighting matrix with reference to the manner in S905, relevant parameters in S905 may be modified according to encoding information of the first component, and then the first weighting matrix may be derived.

In a possible implementation, the first weighting matrix is derived from a weighting matrix (that is, the second weighting matrix) of the second component. In this case, operations at S405-A21 include the following.

At S405-A211, the second weighting matrix of the second component corresponding to the current block is obtained.

At S405-A212, the first weighting matrix is obtained according to the second weighting matrix.

In an example, the second weighting matrix contains at least two different weight values. For example, the minimum weight value is 0 and the maximum weight value is 8, then in the second weighting matrix, weight values of some samples are 0, weight values of some samples are 9, and weight values of other samples are any values between 0 and 8, such as 2.

In an example, all weight values in the second weighting matrix are the same. For example, the minimum weight value is 0 and the maximum weight value is 8, then the weight value of all samples in the second weighting matrix is a value between the minimum weight value and the maximum weight value, such as 4.

In an example, for each sample corresponding to a weight value in the second weighting matrix, a prediction value of the sample in the second component is obtained by predicting using at least two intra prediction modes of the second component. For example, two intra prediction modes are used for the second component. The minimum weight value and the maximum weight value are set as limits for the second weighting matrix. For example, the minimum weight value is set to 0, the maximum weight value is set to 8, and 9 levels (that is, 0-8) are set, where 0 means that a prediction value of a sample in the second component corresponding to the current block is completely obtained from a prediction value derived from an intra prediction mode, and 8 means that a prediction value of a sample in the second component corresponding to the current block is completely obtained by a prediction value derived from another intra prediction mode. Each weight value in the second weighting matrix is greater than 0 and less than 8, for example, the minimum weight value in the second weighting matrix is set to 1 and the maximum weight value is set to 7. Optionally, the second weighting matrix has at least two different weight values.

In an example, the at least two intra prediction modes of the second component include N intra prediction modes, where N is a positive integer greater than or equal to 2. The second weighting matrix has N types of different weight values, where the i-th type of weight value indicates that a prediction value of a sample corresponding to the i-th type of weight value in the second component is obtained from only the i-th intra prediction mode, and i is a positive integer greater than or equal to 2 and less than or equal to N. For example, N is 2, that is, the second component is predicted using two intra prediction modes, called the first intra prediction mode and the second intra prediction mode. The second weighting matrix has two types of weight values, where one of the two types of weight values indicates that a prediction value of a corresponding sample in the second component is completely obtained by predicting using the first intra prediction mode, and the other weight value indicates that a prediction value of a corresponding sample in the second component is completely obtained by predicting using the second intra prediction mode. Optionally, the above two types of weight values are 0 and 1 respectively.

In an example, the at least two intra prediction modes of the second component include the first intra prediction mode and the second intra prediction mode, and the second weighting matrix contains a maximum weight value (for example, 8), a minimum weight value (for example, 0), and at least one middle weight value. The maximum weight value indicates that a prediction value of a corresponding sample in the second component is obtained by predicting using only the first intra prediction mode. The minimum weight value indicates that a prediction value of a corresponding sample in the second component is obtained by predicting using only the second intra prediction mode. The middle weight value indicates that a prediction value of a corresponding sample in the second component is obtained by predicting using the first intra prediction mode and the second intra prediction mode. Optionally, an area formed by the maximum weight value or the minimum weight value may be called a blending area.

In an example, the second weighting matrix contains multiple types of weight values, and locations where the weight values change forms a straight line or curve. For example, when the second weighting matrix contains only 2 types of weight values, locations where the weight values change form a straight line or curve. When the second weighting matrix contains more than 3 types of weight values, locations where the weight values are the same in the blending area form a straight line or curve. Optionally, the formed straight line is a horizontal line or a vertical line. Optionally, the formed straight line may not be a horizontal line or a vertical line.

In an example, the second weighting matrix is a weighting matrix corresponding to the AWP mode or the GPM mode. That is, if one of GPM or AWP is used in the coding standard or the coder to which the solution in the disclosure is applied, the second weighting matrix may be determined based on the same logic as determining a weighting matrix of GPM or AWP. For example, AWP is used for inter prediction in AVS3, and if the solution in the disclosure is applied to AVS3, the second weighting matrix may be determined using the same method for determining a weighting matrix of AWP. Optionally, in the disclosure, the weighting matrix of AWP may be reused. For example, there are 56 weighting matrices of AWP. Assume that 64 weighting matrices are used in intra prediction in this disclosure, and 56 of these 64 weighting matrices are the same as the weighting matrices of AWP, for example, first 56 weighting matrices are the same as the weighting matrices of AWP, and each of the remaining 8 weighting matrices has only one weight value, which may be 1, 2, . . . , 7, or 8 respectively. For these 8 weighting matrices, a sum of weight values is 16, that is, a weight value of 1 represents 1:15 weighting, and a weight value of 2 represents 2:14 weighting. In this way, a 6-bit codeword may be used for binarizing mode numbers of the 64 weighting matrices. In this case, the second weighting matrix in the implementation of the disclosure may be a weighting matrix corresponding to the AWP mode. Optionally, if the solution of the disclosure is applied to AVS3, and GPM is used for inter prediction in AVS3, weighting matrices of GPM may be reused in the implementations of the disclosure. In this case, the second weighting matrix may be a weighting matrix corresponding to GPM.

In addition, since intra prediction utilizes correlation in the spatial domain, reconstructed samples around the current block are used as reference samples. In the spatial domain, the closer the distance, the stronger the correlation, and the farther the distance, the weaker the correlation. Therefore, when the weighting matrix corresponding to the GPM mode or the weighting matrix corresponding to the AWP mode is reused, if using a certain weighting matrix results in that a sample location obtained for a prediction block is farther away from the reference sample, the weighting matrix may not be used in the disclosure.

In should be noted that, in addition to the above, the second weighting matrix may also be obtained in other manners, which is not limited in implementations of the disclosure.

After the second weighting matrix is obtained, operations at S405-A212 are performed, where the first weighting matrix is obtained according to the second weighting matrix. In the disclosure, the manner of obtaining the first weighting matrix according to the second weighting matrix includes but is not limited to the following.
Manner 1, if the number of samples contained in the second component corresponding to the current block is equal to the number of samples contained in the first component of the current block, the second weighting matrix is assigned as the first weighting matrix.
Manner 2, if the number of samples contained in the first component of the current block is less than the number of samples contained in the second component corresponding to the current block, the first weighting matrix is obtained by downsampling the second weighting matrix. For example, the first weighting matrix is obtained by downsampling the second weighting matrix according to the number of samples contained in the first component of the current block and the number of samples contained in the second component corresponding to the current block.

After obtaining the first weighting matrix in the above manner, operations at S405-A22 is performed, where the final prediction block of the first component of the current block is obtained by weighting the prediction blocks corresponding to the intra prediction modes according to the first weighting matrix.

In an example, assuming that the first intra prediction mode and the second intra prediction mode are used for the first component of the current block, then the final prediction block of the first sub-component of the current block is obtained according to formula (1):

predMatrixSawpC[x][y]=(predMatrixC0[x][y]*AwpWeightArrayC[x][y]+predMatrixC1[x][y]*(2ⁿ−AwpWeightArrayC[x][y]+2ⁿ⁻¹)<<n (1)

where C represents the first sub-component, predMatrixSawpC[x][y] represents a final prediction value of sample [x][y] in the first sub-component, predMatrixC0[x][y] represents a first prediction value of sample [x][y] in a first prediction block of the first component of the current block, predMatrixC1[x][y] represents a second prediction value of sample [x][y] in a second prediction block of the first component of the current block, AwpWeightArrayC[x][y] represents a weight value of predMatrixC0[x][y] in the first weighting matrix AwpWeightArrayAB, 2ⁿ is a preset sum of weights, and n is a positive integer. The first prediction block is obtained by predicting using the first intra prediction mode, and the second prediction block is obtained by predicting using the second intra prediction mode.

In an implementation, the first component includes a first sub-component and a second sub-component.

For the first sub-component, operations at S405-A1 include the following. For each of the at least two intra prediction modes of the first component of the current block, a prediction block of the first sub-component corresponding to the intra prediction mode is obtained by performing intra prediction on the first sub-component of the current block using the intra prediction mode. Correspondingly, operations at S405-A22 include the following. A final prediction block of the first sub-component of the current block is obtained by weighting the prediction blocks of the first sub-component corresponding to the intra prediction modes according to the first weighting matrix.

For example, a first prediction block of the first sub-component of the current block is obtained by performing intra prediction on the first sub-component of the current block using the first intra prediction mode, and a second prediction block of the first sub-component of the current block is obtained by performing intra prediction on the first sub-component of the current block using the second intra prediction mode. Then the final prediction block of the first sub-component of the current block is obtained by weighting the first prediction block and the second prediction block of the first sub-component of the current block according to the first weighting matrix.

In a specific example, the final prediction block of the first sub-component of the current block is obtained according to formula (2):

predMatrixSawpA[x][y]=(predMatrixA0[x][y]*AwpWeightArrayAB[x][y]+predMatrixA1[x][y]*(2ⁿ−AwpWeightArrayAB[x][y]+2ⁿ⁻¹)<<n (2)

where A represents the first sub-component, predMatrixSawpA[x][y] represents a final prediction value of sample [x][y] in the first sub-component, predMatrixA0[x][y] represents a first prediction value of sample [x][y] in a first prediction block of the first sub-component of the current block, predMatrixA1[x][y] represents a second prediction value of sample [x][y] in a second prediction block of the first sub-component of the current block, AwpWeightArrayAB[x][y] represents a weight value of predMatrixA0[x][y] in the first weighting matrix AwpWeightArrayAB, 2ⁿ is a preset sum of weights, and n is a positive integer. For example, n=1, 2, or 3, etc.

For the second sub-component, operations at S405-A1 include the following. For each of the at least two intra prediction modes of the first component of the current block, a prediction block of the second sub-component corresponding to the intra prediction mode is obtained by performing intra prediction on the second sub-component of the current block using the intra prediction mode. Correspondingly, operations at S405-A22 include the following. A final prediction block of the second sub-component of the current block is obtained by weighting the prediction blocks of the second sub-component corresponding to the intra prediction modes according to the first weighting matrix.

For example, a first prediction block of the second sub-component of the current block is obtained by performing intra prediction on the second sub-component of the current block using the first intra prediction mode, and a second prediction block of the second sub-component of the current block is obtained by performing intra prediction on the second sub-component of the current block using the second intra prediction mode. Then the final prediction block of the second sub-component of the current block is obtained by weighting the first prediction block and the second prediction block of the second sub-component of the current block according to the first weighting matrix.

In a specific example, the final prediction block of the second sub-component of the current block is obtained according to formula (3):

predMatrixSawpB[x][y]=(predMatrixB0[x][y]*AwpWeightArrayAB[x][y]+predMatrixB1[x][y]*(2ⁿ−AwpWeightArrayAB[x][y]+2ⁿ⁻¹)<<n (3)

where B represents the second sub-component, predMatrixSawpB[x][y] represents a final prediction value of sample [x][y] in the second sub-component, predMatrixB0[x][y] represents a first prediction value of sample [x][y] in a first prediction block of the second sub-component of the current block, predMatrixB1[x][y] represents a second prediction value of sample [x][y] in a second prediction block of the second sub-component of the current block, AwpWeightArrayAB [x][y] represents a weight value of predMatrixB0[x][y] in the first weighting matrix AwpWeightArrayAB, 2ⁿ is a preset sum of weights, and n is a positive integer.

In this disclosure, when at least two intra prediction modes are used for predicting the second component corresponding to the current block, and the initial intra prediction mode of the first component of the current block is determined to be the derivation mode, the method described in the above implementation is applied to obtain at least two intra prediction modes of the first component of the current block according to the at least two intra prediction modes of the second component, and perform intra prediction on the first component of the current block using the at least two intra prediction modes of the first component of the current block. In this way, not only the intra prediction mode of the first component of the current block can be determined simply and efficiently, but also complex textures can be accurately predicted, thereby improving efficiency of video coding. In addition, in the disclosure, since the at least two intra prediction modes of the first component of the current block are derived from the at least two intra prediction modes of the second component, mode information of the at least two intra prediction modes of the first component of the current block can be omitted in a subsequent bitstream, thereby reducing the overhead.

In the disclosure, since the final prediction block is obtained by generating at least two prediction blocks using at least two intra prediction mode and then weighting the at least two prediction blocks according to the weighting matrix, complexity will be increased in comparison with a traditional method of generating one prediction block according to one intra prediction mode. In order to reduce influence of the complexity on the system and balance compression performance and complexity, the disclosure may be restricted from being used for blocks of certain sizes. In other words, the current block in the disclosure has a size satisfying a preset condition.

The preset condition may include one or more of the following conditions.
Condition 1, a width of the current block is greater than or equal to a first preset width TH1, and a height of the current block is greater than or equal to a first preset height TH2. For example, TH1 and TH2 each may be 8, 16, or 32, etc. Optionally, TH1 may be equal to TH2. For example, the height of the current block may be set to be greater than or equal to 8, and the width of the current block may be set to be greater than or equal to 8.
Condition 2, a number of samples in the current block is greater than or equal to a first preset number TH3. TH3 may be 8, 16, or 32, etc.
Condition 3, the width of the current block is less than or equal to a second preset width TH4, and the height of the current block is greater than or equal to a second preset height TH5. TH4 and TH5 each may be 8, 16, or 32, etc. TH4 may be equal to TH5.
Condition 4, a width-height ratio of the current block is a first preset ratio. For example, the first preset ratio may be any of: 1:1, 1:2, 2:1, 4:1, or 1:4.
Condition 5, the size of the current block is not equal to a second preset value. For example, the second preset value is any of: 16×32, 32×32, 16×64, or 64×16.
Condition 6, the height of the current block is greater than or equal to a third preset height, the width of the current block is greater than or equal to a third preset width, a width-height ratio of the current block is less than or equal to a third preset value, and a height-width ratio of the current block is less than or equal to the third preset value. For example, the height of the current block is greater than or equal to 8, the width is greater than or equal to 8, the width-height ratio is less than or equal to 4, and the height-width ratio is less than or equal to 4.

The method in implementations of the disclosure has a better prediction effect on a square or nearly-square block, such as a 1:1 or 1:2 block, while has no obvious effect on a long and thin block, such as a block with a width-height ratio of 16:1 and 32:1. Therefore, in order to reduce influence of the complexity on the system and balance compression performance and complexity, the disclosure is mainly applied to intra prediction of the square or nearly-square block that satisfies the above conditions.

In some implementations, the intra prediction mode of the first component of the current block may include one intra prediction mode. In this case, operations at S404 include but are not limited to the following manners.
Manner 1, one of the at least two intra prediction modes of the second component is assigned as the intra prediction mode of the first component of the current block. For example, if a first intra prediction mode and a second intra prediction mode are used for the second component, the first intra prediction mode is always assigned as the intra prediction mode of the first component of the current block, or the second intra prediction mode is always assigned as the intra prediction mode of the first component of the current block.
Manner 2, one intra prediction mode is derived from the at least two intra prediction modes of the second component, and the derived intra prediction mode is assigned as the intra prediction mode of the first component of the current block. For example, angles used for the first component have larger gaps than that used for the second component, which means that a same intra chroma prediction mode may be derived from different intra luma prediction modes.
Manner 3, the intra prediction mode of the first component of the current block is determined according to an intra prediction mode of the second component corresponding to a first sample location of the current block. For example, the first sample location may be a certain sample location in the lower right corner or in the middle of the current block.

In a possible option of manner 3, if a prediction value of the second component corresponding to the first sample location is obtained by predicting using only one intra prediction mode, the one intra prediction mode is assigned as the intra prediction mode of the first component of the current block.

In a possible option of manner 3, if the prediction value of the second component corresponding to the first sample location is obtained by predicting using multiple intra prediction modes, an intra prediction mode with a maximum weight value among the multiple intra prediction modes is assigned as the intra prediction mode of the first component of the current block.

In a possible option of manner 3, an intra prediction mode of the second component stored in a minimum unit corresponding to the first sample location is assigned as the intra prediction mode of the first component of the current block. In this option, if the prediction value of the second component corresponding to the first sample location is obtained by predicting using only one intra prediction mode, mode information of the one intra prediction mode is stored in the minimum unit. If the prediction value of the second component corresponding to the first sample location is obtained by predicting using multiple intra prediction modes, mode information of an intra prediction mode with a maximum weight value among the multiple intra prediction modes is stored in the minimum unit.

In other words, for intra prediction in the disclosure, information about intra prediction mode(s) can also be stored for reference by a subsequent coding block. According to the adjacent location relationship, an intra prediction mode of a previous coded block, such as an adjacent block, may be used for the subsequent coding block. An intra prediction mode of a previously coded luma block (CU) may be used for a chroma block (CU) according to the location. It should be noted that the information stored here is a reference for the subsequent coding block, because coding mode information in the same block (CU) can be directly obtained, but coding mode information in different blocks (CUs) cannot be directly obtained and thus needs to be stored. The information can be read for the subsequent coding block according to the location. In a method for storing the intra prediction mode used for each block of the current picture, usually a fixed-size matrix, such as a 4×4 matrix, is used as a minimum unit, and each minimum unit stores an intra prediction mode independently. In this way, every time a block is coded, the intra prediction mode(s) of this block may be stored in the minimum unit(s) corresponding to a location of the block. As illustrated in FIG. 11B, if intra prediction mode 5 is used for a 16×16 block, then each of the intra prediction modes stored in all 4×4 minimum units corresponding to this block is intra prediction mode 5. For the YUV format, generally only intra luma prediction modes are stored.

For example, if the at least two intra prediction modes of the second component include the first intra prediction mode and the second intra prediction mode, the intra prediction mode may be stored in the minimum unit in the following manners.

In one manner, some of the minimum units store the first intra prediction mode, and some of the minimum units store the second intra prediction mode. A specific implementation is similar to GPM or AWP. If one of GPM or AWP is used in a coding standard or coder to which the solution of the disclosure is applied, then the disclosure can use a logic similar to GPM or AWP, or can reuse part of the same logic. For example, AWP is used for inter prediction in AVS3, then in AVS3, a logic similar to storing 2 different motion information for AWP can be used to store 2 different intra prediction modes of the second component. That is, for the location corresponding to the minimum unit, if only the first intra prediction mode is used to determine the prediction block, then this minimum unit will store the first intra prediction mode, if only the second intra prediction mode is used to determine the prediction block, then this minimum unit will store the second intra prediction mode, and if both the first intra prediction mode and the second intra prediction mode are used to determine the prediction block, then one of the first and the second intra prediction modes will be stored according to a certain determination method, for example, the one with a greater weight among the first intra prediction mode and the second prediction mode will be stored.

In another manner, all minimum units corresponding to the same current block store the same intra prediction mode. For example, according to the derivation mode of the second weighting matrix, whether all minimum units of the current block are to store the first intra prediction mode or the second intra prediction mode is determined. Assume that the derivation mode of the second weighting matrix in this disclosure is the same as the derivation mode of the weighting matrix of AWP, where the AWP includes 56 weighting-matrix derivation modes, as illustrated in FIG. 4B for details. As illustrated in Table 3 below, if a mode number of the derivation mode of the second weighting matrix corresponds to 0, all minimum units of the current block store the first intra prediction mode, and if the mode number of the matrix derivation mode corresponds to 1, all minimum units of the current block store the second intra prediction mode.

TABLE 3

| | | | | | | | |
|---|---|---|---|---|---|---|---|
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 0 | 0 | 0 | 0 |
| 0 | 0 | 0 | 0 | 1 | 0 | 0 | 0 |
| 1 | 0 | 0 | 1 | 1 | 1 | 0 | 1 |
| 1 | 1 | 0 | 1 | 1 | 1 | 0 | 1 |

Based on the above description, in the disclosure, the intra prediction mode of the second component is stored in the corresponding minimum unit according to the location, so that in determination of the intra prediction mode of the first component of the current block, the intra prediction mode of the second component stored in the minimum unit corresponding to the first sample location may be assigned as the intra prediction mode of the first component of the current block.

In some implementations, if the current block in the disclosure only includes the first component and does not include the second component, for example, only includes the chroma component but does not include the luma component, that is, the current block in the disclosure is a chroma block, then the intra prediction mode of the first component of the current block may be determined in the following manner. For example, the intra prediction mode of the first component of the current block is determined according to an existing method. For instance, the intra prediction mode of the second component is found according to a location, and the found intra prediction mode of the second component is assigned as the intra prediction mode of the first component of the current block. The intra prediction mode of the first component of the current block includes one intra prediction mode.

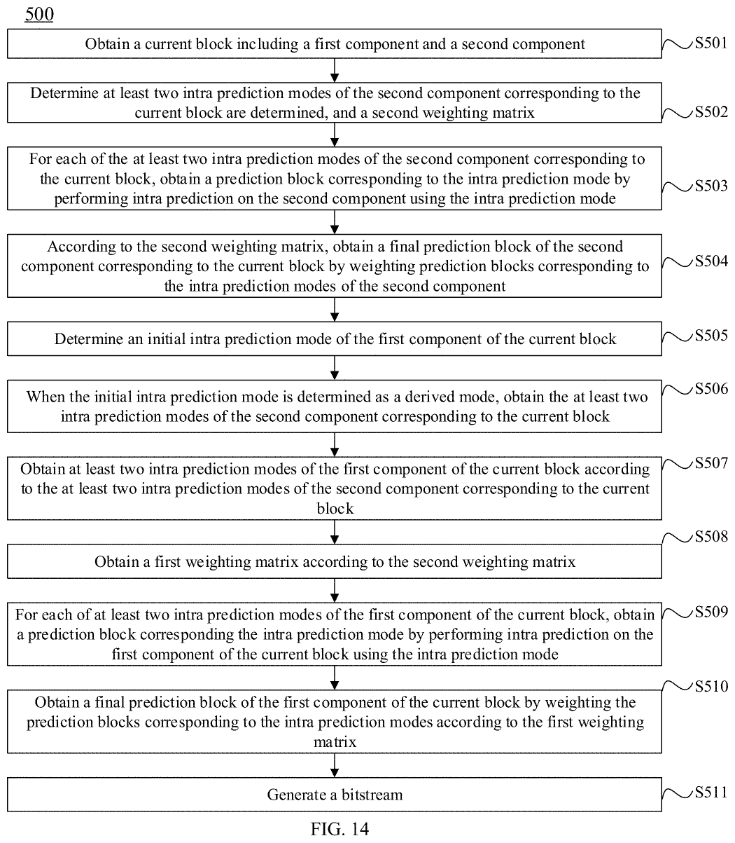

FIG. 14 is another schematic flowchart of a video encoding method 500 provided in implementations of the disclosure. In this implementation, exemplarily, at least two intra prediction modes are used for the first component. As illustrated in FIG. 14, the method includes the following.

At S501, a current block is obtained, where the current block includes a first component and a second component. For example, a target picture is obtained and divided to obtain the current block. Optionally, the current block further includes the second component.

At S502, at least two intra prediction modes of the second component corresponding to the current block are determined, and a second weighting matrix is determined.

At encoding end, when an encoder determines the at least two intra prediction modes and the second weighting matrix of the second component corresponding to the current block, the encoder will try all or part of combinations of different intra prediction modes and different weighting matrices. According to an encoding cost of each combination, the encoder assigns at least two intra prediction modes corresponding to a combination with the minimum encoding cost as the at least two intra prediction modes of the second component corresponding to the current block, and assigns a weighting matrix corresponding to the combination as the second weighting matrix.

For example, the at least two intra prediction modes of the second component corresponding to the current block include a first intra prediction mode and a second intra prediction mode. All possible combinations include combinations of all possible modes of the first intra prediction mode, all possible modes of the second intra prediction mode, and all possible modes of a weighting-matrix derivation mode. Assuming that there are 66 available intra prediction modes in this disclosure, the first intra prediction mode has 66 possibilities, and since the second intra prediction mode is different from the first intra prediction mode, the second intra prediction mode has 65 possibilities. Assuming that there are 56 weighting-matrix derivation modes (taking AWP as an example), then any two different intra prediction modes and any weighting-matrix derivation mode may combined in the disclosure, leading to a total of 66×65×56 possible combinations.

In one possible manner, rate distortion optimization (RDO) is performed on all possible combinations, and a combination with the lowest cost will be determined. Two intra prediction modes corresponding to the combination are determined as the first intra prediction mode and the second intra prediction mode, and a weighting matrix corresponding to the combination is assigned as the second weighting matrix.

In another possible manner, all possible combinations are primarily selected. For example, an approximate cost such as a sum of absolute difference (SAD) or a sum of absolute transformed difference (SATD), etc. is used for primary selection to determine a preset number of candidate combinations of the first intra prediction mode, the second intra prediction mode, and the weighting-matrix derivation mode. Afterwards, a fine selection is performed with RDO to determine a combination of the first intra prediction mode, the second intra prediction mode, and the weighting-matrix derivation mode with the lowest cost. Some fast algorithms may be used in the primary selection to reduce the number of tries. For example, when an intra angular prediction mode causes a high cost, several intra prediction modes adjacent to the intra angular prediction mode will not be tried.

During the above primary selection and fine selection, a first prediction block will be determined according to the first intra prediction mode, a second prediction block will be determined according to the second intra prediction mode, and a weighting matrix will be derived according to the weighting-matrix derivation mode. According to the first prediction block, the second prediction block, and weighting matrix, the final predicted block will be determined. During primary selection with SAD and SATD, the current block and the prediction block are used to determine SAD and SATD.

Optionally, the encoder may first analyze a texture of the current block, for example, by using gradients. The analyzed data may help primary selection. For example, if the texture of the current block is stronger in a direction, more intra prediction modes in directions approximate to the direction will be selected during the above-mentioned primary selection. For example, if the texture of the current block is weaker in a direction, less intra prediction modes in directions approximate to the direction will be selected during the above-mentioned primary selection.

The encoding cost mentioned above includes a cost of codewords occupied by the first intra prediction mode, the second intra prediction mode, and the weighting-matrix derivation mode in the bitstream, a cost of various flags and quantized coefficients to be transmitted in the bitstream for transformation, quantization, entropy encoding, etc. of the residuals, and a cost of distortion of the reconstructed block, etc.

Further, the encoder signallings information of the determined first intra prediction mode, second intra prediction mode and second weighting-matrix derivation mode of the second component corresponding to the current block into the bitstream according to the syntax.

At S503, for each of the at least two intra prediction modes of the second component corresponding to the current block, a prediction block corresponding to the intra prediction mode is obtained by performing intra prediction on the second component using the intra prediction mode.

At S504, according to the second weighting matrix, a final prediction block of the second component corresponding to the current block is obtained by weighting prediction blocks corresponding to the intra prediction modes of the second component.

At S505, an initial intra prediction mode of the first component of the current block is determined.

At S506, when the initial intra prediction mode is determined as a derivation mode, the at least two intra prediction modes of the second component corresponding to the current block are obtained.

At S507, at least two intra prediction modes of the first component of the current block are obtained according to the at least two intra prediction modes of the second component corresponding to the current block. For example, the at least two intra prediction modes of the second component corresponding to the current block are directly assigned as the at least two intra prediction modes of the first component of the current block.

At S508, a first weighting matrix is obtained according to the second weighting matrix. For example, if a number of samples contained in the second component corresponding to the current block is equal to a number of samples contained in the first component of the current block, the second weighting matrix is assigned as the first weighting matrix. If the number of samples contained in the first component of the current block is less than the number of samples contained in the second component corresponding to the current block, the first weighting matrix is obtained by downsampling the second weighting matrix. Optionally, the first weighting matrix is derived according to the weighting-matrix derivation mode.

It should be noted that operations at S507 and S508 may be performed in any order.

At S509, for each of at least two intra prediction modes of the first component of the current block, a prediction block corresponding the intra prediction mode is obtained by performing intra prediction on the first component of the current block using the intra prediction mode.

At S510, a final prediction block of the first component of the current block is obtained by weighting the prediction blocks corresponding to the intra prediction modes according to the first weighting matrix.

At S511, a bitstream is generated, where the bitstream includes a weighted-prediction flag, and the weighted-prediction flag indicates whether a prediction block of the second component is obtained by predicting using the at least two intra prediction modes.

Optionally, the bitstream further includes mode information of the at least two intra prediction modes of the second component corresponding to the current block.

Optionally, the bitstream further includes mode information of the derived-mode of the second weighting matrix.

Optionally, the bitstream further includes mode information of the derivation mode of the first component of the current block.

Optionally, if the first weighting matrix is determined according to the weighting-matrix derivation mode, the bitstream may include mode information of the derivation mode of the first weighting matrix.

In some implementations, if it is determined that the at least two intra prediction modes are used for prediction of the second component corresponding to the current block, the initial intra prediction mode of the first component of the current block is determined as the derivation mode, such as DM mode. In this case, when the intra prediction mode of the first component of the current block is determined as the derivation mode, the mode information of the derivation mode will not be carried in the bitstream.

After obtaining the final prediction block of the current block, the encoder performs subsequent processing, including decoding of quantized coefficients, inverse transformation and inverse quantization to determine a residual block, combining the residual block and the prediction block into a reconstructed block, and subsequent loop filtering, etc.

In the present disclosure, both the first component and the second component can be predicted using at least two intra prediction modes, so that more complex prediction blocks can be obtained, thereby improving quality of intra prediction and thus improving compression performance. Compared with the existing technology, not only complex textures can be predicted, but also transmission of mode information can be reduced in the bitstream by using the correlation between channels, which effectively improves the coding efficiency.

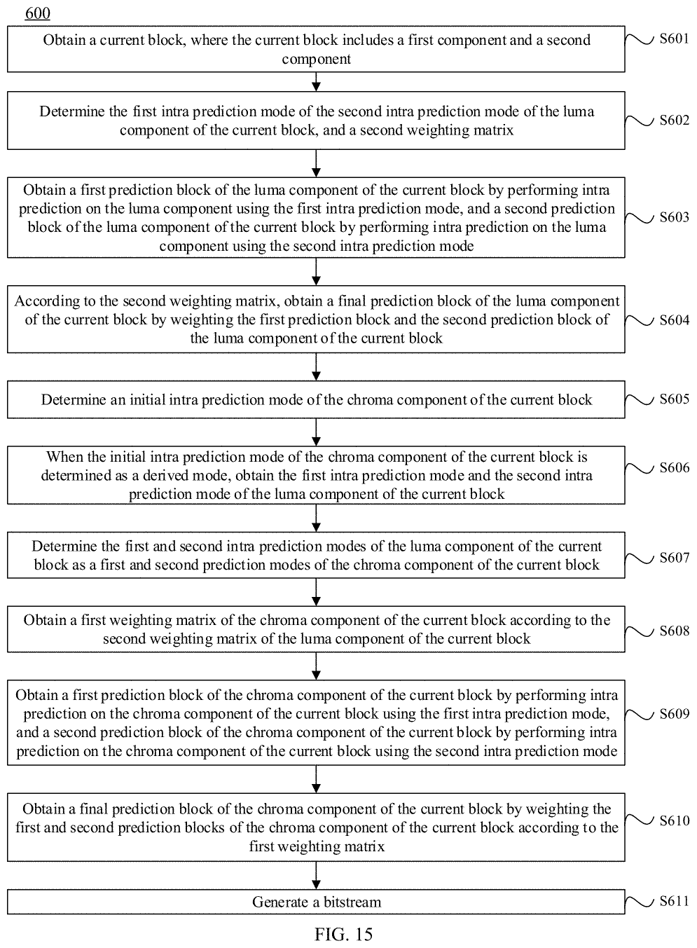

FIG. 15 is another schematic flowchart of a video encoding method 600 provided in implementations of the disclosure. In this implementation, the first component is a chroma component, and the second component is a luma component. At least two intra prediction modes of the luma component of the current block include a first intra prediction mode and a second intra prediction mode. Two intra prediction modes are used for the chroma component. As illustrated in FIG. 15, the method includes the following.

At S601, a current block is obtained, where the current block includes a chroma component and a luma component.

At S602, the first intra prediction mode and the second intra prediction mode of the luma component of the current block are determined, and a second weighting matrix is determined.

At S603, a first prediction block of the luma component of the current block is obtained by performing intra prediction on the luma component using the first intra prediction mode, and a second prediction block of the luma component of the current block is obtained by performing intra prediction on the luma component using the second intra prediction mode.

At S604, according to the second weighting matrix, a final prediction block of the luma component of the current block is obtained by weighting the first prediction block and the second prediction block of the luma component of the current block.

At S605, an initial intra prediction mode of the chroma component of the current block is determined.

At S606, when the initial intra prediction mode of the chroma component of the current block is determined as a derivation mode, the first intra prediction mode and the second intra prediction mode of the luma component of the current block are obtained.

At S607, the first and second intra prediction modes of the luma component of the current block are determined as a first and second prediction modes of the chroma component of the current block.

At S608, a first weighting matrix of the chroma component of the current block is obtained according to the second weighting matrix of the luma component of the current block.

At S609, a first prediction block of the chroma component of the current block is obtained by performing intra prediction on the chroma component of the current block using the first intra prediction mode, and a second prediction block of the chroma component of the current block is obtained by performing intra prediction on the chroma component of the current block using the second intra prediction mode.

At S610, a final prediction block of the chroma component of the current block is obtained by weighting the first and second prediction blocks of the chroma component of the current block according to the first weighting matrix.

At S611, a bitstream is generated, where the bitstream includes a weighted-prediction flag, and the weighted-prediction flag indicates whether a prediction block of the luma component of the current block is obtained by predicting using the at least two intra prediction modes.

Optionally, the bitstream further includes mode information of the at least two intra prediction modes of the luma component of the current block.

Optionally, the bitstream further includes mode information of the derivation mode of the chroma component of the current block.

In some implementations, when it is determined that the at least two intra prediction modes are used for prediction of the luma component of the current block, the intra prediction mode of the chroma component of the current block is determined as the derivation mode.

In this case, when the intra prediction mode of the chroma component of the current block is determined as the derivation mode, the mode information of the derivation mode will not be carried in the bitstream.

After obtaining the final prediction block of the current block, the encoder performs subsequent processing, including decoding of quantized coefficients, inverse transformation and inverse quantization to determine a residual block, combining the residual block and the prediction block into a reconstructed block, and subsequent loop filtering, etc.

The video encoding method involved in implementations of the present disclosure are described above. On this basis, the following will describe a video decoding method at decoding end involved in the present disclosure.

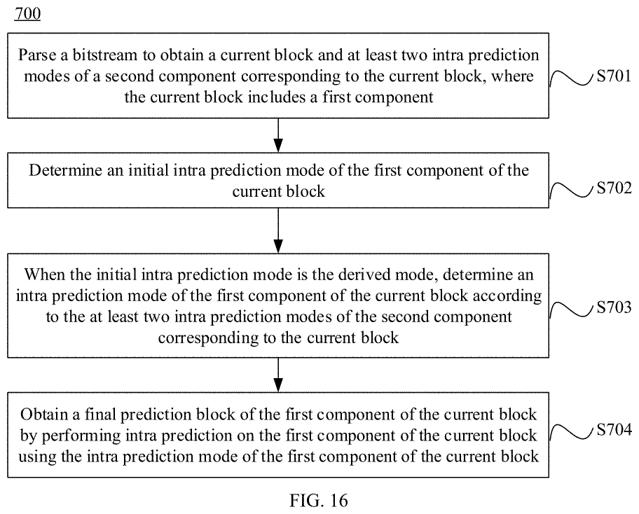

FIG. 16 is a schematic flowchart of a video decoding method 700 provided in implementations of the disclosure. As illustrated in FIG. 16, the method in the implementations of the disclosure includes the following.

At S701, a bitstream is parsed to obtain a current block and at least two intra prediction modes of a second component corresponding to the current block. The current block includes a first component.

The bitstream in the disclosure carries mode information of the at least two intra prediction modes used in intra prediction for the second component corresponding to the current block, so the mode information of the at least two intra prediction modes of the second component corresponding to the current block can be obtained by parsing the bitstream. As such, the at least two intra prediction modes used in intra prediction for the second component corresponding to the current block can be obtained.

In some implementations, the current block in the disclosure has a size satisfying a preset condition.

The preset condition includes one or more of the following.

Condition 1, a width of the current block is greater than or equal to a first preset width TH1, and a height of the current block is greater than or equal to a first preset height TH2. For example, TH1 and TH2 each may be 8, 16, or 32, etc. Optionally, TH1 may be equal to TH2. For example, the height of the current block may be set to be greater than or equal to 8, and the width of the current block may be set to be greater than or equal to 8.

Condition 2, a number of samples in the current block is greater than or equal to a first preset number TH3. TH3 may be 8, 16, or 32, etc.

Condition 3, the width of the current block is less than or equal to a second preset width TH4, and the height of the current block is greater than or equal to a second preset height TH5. TH4 and TH5 each may be 8, 16, or 32, etc. TH4 may be equal to TH5.

Condition 4, a width-height ratio of the current block is a first preset ratio. For example, the first preset ratio may be any of: 1:1, 1:2, 2:1, 4:1, or 1:4.

Condition 5, the size of the current block is not equal to a second preset value. For example, the second preset value is any of: 16×32, 32×32, 16×64, or 64×16.

Condition 6, the height of the current block is greater than or equal to a third preset height, the width of the current block is greater than or equal to a third preset width, a width-height ratio of the current block is less than or equal to a third preset value, and a height-width ratio of the current block is less than or equal to the third preset value. For example, the height of the current block is greater than or equal to 8, the width is greater than or equal to 8, the width-height ratio is less than or equal to 4, and the height-width ratio is less than or equal to 4.

At S702, an initial intra prediction mode of the first component of the current block is determined.

Specifically, if the initial intra prediction mode of the first component of the current block carried in the bitstream is not a derivation mode, the initial intra prediction mode carried in the bitstream will be used for intra prediction of the first component of the current block. If the initial intra prediction mode of the current block carried in the bitstream is the derivation mode, operations at S703 will be performed. If the bitstream does not carry mode information of the initial intra prediction mode of the first component of the current block, the initial intra prediction mode of the first component of the current block is default to the derivation mode, and operations at S703 will be performed.

At S703, when the initial intra prediction mode is the derivation mode, an intra prediction mode of the first component of the current block is determined according to the at least two intra prediction modes of the second component corresponding to the current block.

In some implementations, the intra prediction mode of the first component of the current block includes at least two intra prediction modes. In this case, operations at S703 include but are not limited to the following.
Manner 1, the at least two intra prediction modes of the second component are determined as the intra prediction modes of the first component of the current block.
Manner 2, the intra prediction modes of the first component of the current block are derived according to the at least two intra prediction modes of the second component.

In some implementations, the intra prediction mode of the first component of the current block may include one intra prediction mode. In this case, operations at S703 include but are not limited to the following.
Manner 1, one of the at least two intra prediction modes of the second component is assigned as the intra prediction mode of the first component of the current block. For example, if the first intra prediction mode and the second intra prediction mode are used for the second component, the first intra prediction mode is always assigned as the intra prediction mode of the first component of the current block, or the second intra prediction mode is always assigned as the intra prediction mode of the first component of the current block.
Manner 2, one intra prediction mode is derived from the at least two intra prediction modes of the second component, and the derived intra prediction mode is assigned as the intra prediction mode of the first component of the current block. For example, angles used for the first component have larger gaps than that used for the second component, which means that a same intra chroma prediction mode may be derived from different intra luma prediction modes.
Manner 3, the intra prediction mode of the first component of the current block is determined according to an intra prediction mode of the second component corresponding to a first sample location of the current block.

In a possible option of manner 3, if a prediction value of the second component corresponding to the first sample location is obtained by predicting using only one intra prediction mode, the one intra prediction mode is assigned as the intra prediction mode of the first component of the current block.

In a possible option of manner 3, if the prediction value of the second component corresponding to the first sample location is obtained by predicting using multiple intra prediction modes, an intra prediction mode with a maximum weight value among the multiple intra prediction modes is assigned as the intra prediction mode of the first component of the current block.

In a possible option of manner 3, an intra prediction mode of the second component stored in a minimum unit corresponding to the first sample location is assigned as the intra prediction mode of the first component of the current block. In this option, if the prediction value of the second component corresponding to the first sample location is obtained by predicting using one intra prediction mode, mode information of the one intra prediction mode is stored in the minimum unit. If the prediction value of the second component corresponding to the first sample location is obtained by predicting using multiple intra prediction modes, mode information of an intra prediction mode with a maximum weight value among the multiple intra prediction modes is stored in the minimum unit.

At S704, a final prediction block of the first component of the current block is obtained by performing intra prediction on the first component of the current block using the intra prediction mode of the first component of the current block.

If the intra prediction mode of the first component of the current block includes at least two intra prediction modes, operations at S704 include the following.

At S704-A1, for each of the at least two intra prediction modes of the first component of the current block, a prediction block corresponding the intra prediction mode is obtained by performing intra prediction on the first component of the current block using the intra prediction mode.

At S704-A2, the final prediction block of the first component of the current block is obtained according to the prediction blocks corresponding to the at least two intra prediction modes.

In an implementation, operations at S704-A2 include operations at S704-A21 and S704-A22.

At S704-A21, a first weighting matrix is determined.

At S704-A22, the final prediction block of the first component of the current block is obtained by weighting the prediction blocks corresponding to the intra prediction modes according to the first weighting matrix.

In a possible implementation, the first weighting matrix is derived according to the weighting-matrix derivation mode.

In a possible implementation, the first weighting matrix is derived from a weighting matrix (called second weighting matrix) of the second component. In this case, operations at S704-A21 include the following.

At S704-A211, a second weighting matrix of the second component corresponding to the current block is obtained.

At S704-A212, the first weighting matrix is obtained according to the second weighting matrix.

In an example, the second weighting matrix contains at least two different weight values. For example, the minimum weight value is 0 and the maximum weight value is 8, then in the second weighting matrix, weight values of some samples are 0, weight values of some samples are 9, and weight values of other samples are any value between 0 and 8, such as 2.

In an example, all weight values in the second weighting matrix are the same. For example, the minimum weight value is 0 and the maximum weight value is 8, then the weight value of all samples in the second weighting matrix is a value between the minimum weight value and the maximum weight value, such as 4.

In an example, a prediction value of the sample corresponding to each weight value in the second weighting matrix of the second component is obtained by predicting using at least two intra prediction modes of the second component.

In an example, the at least two intra prediction modes of the second component include N intra prediction modes, where N is a positive integer greater than or equal to 2. The second weighting matrix has N types of different weight values, where the i-th type of weight value indicates that the prediction value of the sample corresponding to the i-th weight value in the second component is completely obtained from the i-th intra prediction mode, and i is a positive integer greater than or equal to 2 and less than or equal to N.

In an example, the at least two intra prediction modes of the second component include the first intra prediction mode and the second intra prediction mode, and the second weighting matrix includes a maximum weight value (for example, 8), a minimum weight value (for example, 0) and at least one middle weight value. The maximum weight value indicates that a prediction value of a corresponding sample in the second component is obtained by predicting using only the first intra prediction mode. The minimum weight value indicates that a prediction value of a corresponding sample in the second component is obtained by predicting using only the second intra prediction mode. The middle weight value indicates that a prediction value of a corresponding sample in the second component is obtained by predicting using both the first intra prediction mode and the second intra prediction mode. Optionally, an area formed by the maximum weight value or the minimum weight value may be called a blending area.

In an example, the second weighting matrix contains multiple types of weight values, and locations where the weight values change forms a straight line or curve.

In an example, the second weighting matrix is a weighting matrix corresponding to the AWP mode or the GPM mode.

After the second weighting matrix is obtained, operations of S704-A212 are performed, where the first weighting matrix is obtained according to the second weighting matrix. In the disclosure, the manner of obtaining the first weighting matrix according to the second weighting matrix includes but is not limited to the following manners.
Manner 1, if the number of samples contained in the second component corresponding to the current block is equal to the number of samples contained in the first component of the current block, the second weighting matrix is assigned as the first weighting matrix.
Manner 2, if the number of samples contained in the first component of the current block is less than the number of samples contained in the second component corresponding to the current block, the first weighting matrix is obtained by downsampling the second weighting matrix. For example, the first weighting matrix is obtained by downsampling the second weighting matrix according to the number of samples contained in the second component corresponding to the current block and the number of samples contained in the first component of the current block.

In an implementation, the first component includes a first sub-component and a second sub-component.

For the first sub-component, operations at S704-A1 include the following. For each of the at least two intra prediction modes of the first component of the current block, a prediction block of the first sub-component corresponding to the intra prediction mode is obtained by performing intra prediction on the first sub-component of the current block using the intra prediction mode. Correspondingly, operations at S704-A22 include the following. A final prediction block of the first sub-component of the current block is obtained by weighting the prediction blocks of the first sub-component corresponding to the intra prediction modes according to the first weighting matrix.

For example, a first prediction block of the first sub-component of the current block is obtained by performing intra prediction on the first sub-component of the current block using the first intra prediction mode, and a second prediction block of the first sub-component of the current block is obtained by performing intra prediction on the first sub-component of the current block using the second intra prediction mode. Then the final prediction block of the first sub-component of the current block is obtained by weighting the first prediction block and the second prediction block of the first sub-component of the current block according to the first weighting matrix.

In a specific example, the final prediction block of the first sub-component of the current block is obtained according to formula (2) mentioned above.

For the second sub-component, operations at S704-A1 include the following. For each of the at least two intra prediction modes of the first component of the current block, a prediction block of the second sub-component corresponding to the intra prediction mode is obtained by performing intra prediction on the second sub-component of the current block using the intra prediction mode. Correspondingly, operations at S704-A22 include the following. A final prediction block of the second sub-component of the current block is obtained by weighting the prediction blocks of the second sub-component corresponding to the intra prediction modes according to the first weighting matrix.

For example, a first prediction block of the second sub-component of the current block is obtained by performing intra prediction on the second sub-component of the current block using the first intra prediction mode, and a second prediction block of the second sub-component of the current block is obtained by performing intra prediction on the second sub-component of the current block using the second intra prediction mode. Then the final prediction block of the second sub-component of the current block is obtained by weighting the first prediction block and the second prediction block of the second sub-component of the current block according to the first weighting matrix.

In a specific example, the final prediction block of the second sub-component of the current block is obtained according to formula (3) mentioned above.

Some operations at decoding end are the same as that at the encoding end, which can be referred to the description related to the encoding end and will not be repeated herein.

After obtaining the final prediction block of the current block, the decoder performs subsequent processing, including decoding of quantized coefficients, inverse transformation and inverse quantization to determine a residual block, combining the residual block and the prediction block into a reconstructed block, and subsequent loop filtering, etc.

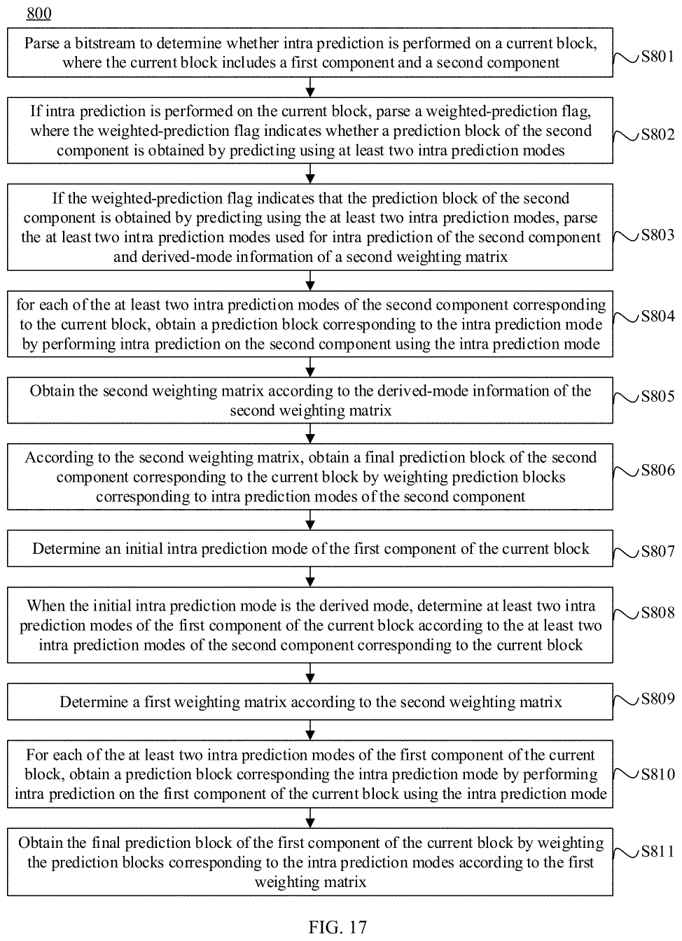

FIG. 17 is a schematic flowchart of a video decoding method 800 provided in implementations of the disclosure. As illustrated in FIG. 17, the method in the implementations of the disclosure includes the following.

At S801, a bitstream is parsed, and whether intra prediction is performed on a current block is determined, where the current block includes a first component and a second component.

At S802, based on a determination that intra prediction is performed on the current block, a weighted-prediction flag is parsed, where the weighted-prediction flag indicates whether a prediction block of the second component is obtained by predicting using at least two intra prediction modes.

At S803, if the weighted-prediction flag indicates that the prediction block of the second component is obtained by predicting using the at least two intra prediction modes, the at least two intra prediction modes used for intra prediction of the second component corresponding to the current block are parsed, and derivation mode information of a second weighting matrix is parsed.

At S804, for each of the at least two intra prediction modes of the second component corresponding to the current block, a prediction block corresponding to the intra prediction mode is obtained by performing intra prediction on the second component using the intra prediction mode.

At S805, the second weighting matrix is obtained according to the derivation mode information of the second weighting matrix.

It should be noted that operations at S804 and S805 may be executed in any order.

At S806, according to the second weighting matrix, a final prediction block of the second component corresponding to the current block is obtained by weighting prediction blocks corresponding to intra prediction modes of the second component.

At S807, an initial intra prediction mode of the first component of the current block is determined. Specifically, if the initial intra prediction mode of the first component of the current block carried in the bitstream is not a derivation mode, the initial intra prediction mode carried in the bitstream will be used for intra prediction of the first component of the current block. If the initial intra prediction mode of the first component of the current block carried in the bitstream is the derivation mode, operations at S808 will be performed. If the bitstream does not carry the mode information of the initial intra prediction mode of the first component of the current block, the initial intra prediction mode of the first component of the current block is default to the derivation mode, and operations at S808 will be performed.

At S808, when the initial intra prediction mode is the derivation mode, at least two intra prediction modes of the first component of the current block are determined according to the at least two intra prediction modes of the second component corresponding to the current block. For example, the at least two intra prediction modes of the second component are directly assigned as the at least two intra prediction modes of the first component of the current block.

At S809, a first weighting matrix is determined according to the second weighting matrix. For example, if the number of samples contained in the second component corresponding to the current block is equal to the number of samples contained in the first component of the current block, the second weighting matrix is assigned as the first weighting matrix. If the number of samples contained in the first component of the current block is less than the number of samples contained in the second component corresponding to the current block, the first weighting matrix is obtained by downsampling the second weighting matrix.

It should be noted that operations at S808 and S809 may be executed in any order.

At S810, for each of the at least two intra prediction modes of the first component of the current block, a prediction block corresponding the intra prediction mode is obtained by performing intra prediction on the first component of the current block using the intra prediction mode.

At S811, the final prediction block of the first component of the current block is obtained by weighting the prediction blocks corresponding to the intra prediction modes according to the first weighting matrix.

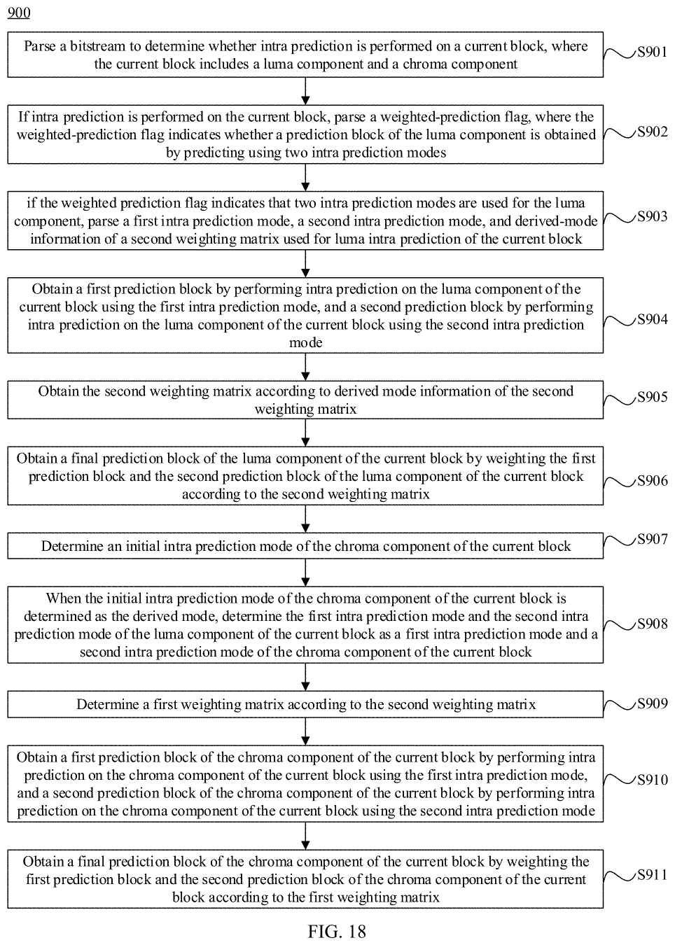

FIG. 18 is a schematic flowchart of a video decoding method 900 provided in implementations of the disclosure. In this implementation, exemplarily, the first component is a chroma component, the second component is a luma component, the at least two intra prediction modes of the luma component are a first intra prediction mode and a second intra prediction mode, and two intra prediction modes are used for the chroma component. As illustrated in FIG. 18, the method in the implementations of the disclosure includes the following.

At S901, a bitstream is parsed, and whether intra prediction is performed on a current block is determined, where the current block includes a luma component and a chroma component.

At S902, based on a determination that intra prediction is performed on the current block, a weighted-prediction flag is parsed, where the weighted-prediction flag indicates whether a prediction block of the luma component is obtained by predicting using two intra prediction modes.

In an example, the technology in this disclosure may be called spatial angular weighted prediction (SAWP). A sequence-level flag may be carried in the bitstream to indicate whether the SAWP is used for the current block. For example, Table 4 illustrates definition of a sequence header.

TABLE 4

| Definition of sequence header | descriptor |
|---|---|
| sequence_header( ) { | |
| ...... | |
| sawp_enable_flag | u(1) |
| ...... | |

In Table 4, sawp_enable_flag represents a SAWP enabled flag, which is a binary variable. sawp_enable_flag with value “1” indicates that the SAWP is enabled, and sawp_enable_flag with value “0” indicates that the SAWP is disabled. The value of SawpEnableFlag is equal to the value of sawp_enable_flag. If sawp_enable_flag does not exist in the bitstream, the value of SawpEnableFlag should be “0”.

Optionally, there may be a frame-level flag to determine whether the SAWP technology is used for the current picture to-be-decoded. For example, it may be configured that the SAWP technology is used for an intra frame (such as I frame) and is not used for an inter frame (such as B frame or P frame). Optionally, it may be configured that the SAWP technology is not used for the intra frame and is used for the inter frame. Optionally, it may be configured that the SAWP technology is used for some inter frames and is not used for other inter frames.

Optionally, there may be a flag below frame-level and above CU-level (such as tile, slice, patch, LCU, etc.) to indicate whether the SAWP technology is used for a region corresponding to the flag.

For example, the decoder executes the following program:

```
      ......
      if (! DirectFlag && (mode == ‘PRED_No_Constraint’))
        intra_cu_flag
    }
  }
  PartSize = ‘SIZE_2Mx2N’
  If(SawpEnableFlag&& IntraCuFlag&&width>=SawpMinSize&&
height>=SawpMinSize&&width*SawpMaxRatio>=height&&height*SawpMaxRa
tio>=width){
    sawp_flag
  }
  if (DtEnableFlag && IntraCuFlag&&!SawpFlag) {
    dt_split_flag
  ......
```

intra_cu_flag is an intra prediction flag. sawp_flag is a weighted prediction flag which is a binary variable. sawp_flag with value “1” indicates that the SAWP should be performed, that is, at least two intra prediction modes are used for the luma component. sawp_flag with value “0” indicates that the SAWP should not be performed, that is, only one intra prediction mode is used for the luma component. The value of SawpFlag is equal to the value of sawp_flag. If sawp_flag does not exist in the bitstream, SawpFlag has a value of 0.

Specifically, the decoder decodes the current block. If determining that intra prediction is used for the current block, the decoder decodes the SAWP enabled flag (i.e. the value of sawp_flag). If determining that intra prediction is not used for the current block, the decoder does not need to decode the SAWP enabled flag. Optionally, if the SAWP is used for the current block, the decoder does not need to decode DT or IPF related information, since DT or IPF and SAWP are mutually exclusive.

At S903, if the weighted prediction flag indicates that two intra prediction modes are used for the luma component, a first intra prediction mode, a second intra prediction mode, and derivation mode information of a second weighting matrix used for luma intra prediction of the current block are parsed.

If the weighted prediction flag indicates that two intra prediction modes are used for the luma component, the decoder parses the first intra prediction mode, the second intra prediction mode, and the derivation mode information of the second weighting matrix used for luma intra prediction of the current block.

In some implementations, the decoder executes the following program to obtain mode information of the first intra prediction mode and the second intra prediction mode of the luma component of the current block.

```
  ......
  if ((SawpFlag) {
    sawp_idx
    intra_luma_pred_mode0
    intra_luma_pred_mode1
  }
......
```

sawp_idx represents the derivation mode information of the second weighting matrix. The value of SawpIdx is equal to the value of sawp_idx. If the bitstream does not include sawp_idx, the value of SawpIdx is 0. intra_luma_pred_mode0 represents mode information of the first intra prediction mode of the luma component of the current block, and intra_luma_pred_mode1 represents mode information of the second intra prediction mode of the luma component of the current block.

In this operation, sawp_idx is parsed in the same manner as awp_idx, intra_luma_pred_mode0 is parsed in the same manner as intra_luma_pred_mode, and intra_luma_pred_mode1 is parsed in the same manner as intra_luma_pred_mode. Optionally, since there are only two MPMs in AVS3, if intra_luma_pred_mode0 and intra_luma_pred_mode1 are both used as MPMs and intra_luma_pred_mode0 is used as one of the two MPMs, intra_luma_pred_mode1 is default to be the other one, so that there is no need to parse intra_luma_pred_mode1 to determine whether intra_luma_pred_mode1 is the first or second mode of the two MPMs.

In some implementations, the decoder executes the following program to obtain the mode information of the first intra prediction mode and the second intra prediction mode, and the derivation mode information of the second weighting matrix.

```
  ......
  dt_split_flag
  ......
  intra_luma_pred_mode
  ......
  ipf_flag
  ......
  If(SawpEnableFlag&& ! DtSplitFlag &&!IpfFlag &&
IntraCuFlag&&width>=SawpMinSize&&
height>=SawpMinSize&&width*SawpMaxRatio>=height&&height*SawpMaxRa
tio>=width){
  sawp_flag
  }
  if ((SawpFlag) {
  sawp_idx
  intra_luma_pred_mode1
  }
  ......
```

Specifically, the decoder decodes the current block. If intra prediction is used for the current block, the decoder decodes a DT enabled flag and an IPF enabled flag of the current block, and a unique luma prediction mode intra_luma_pred_mode of each prediction unit in the current method. If neither DT nor IPF is used for the current block, the decoder decodes a SAWP enabled flag of the current block. If SAWP is used for the current block, the decoder needs to decode a derivation mode of the second weighting matrix and intra_luma_pred_mode1. intra_luma_pred_mode is used as mode information of the first intra prediction mode of the luma component of the current block, and intra_luma_pred_mode1 is used as mode information of the second intra prediction mode of the luma component of the current block.

According to intra_luma_pred_mode0 and intra_luma_pred_mode1, IntraLumaPredMode0 and IntraLumaPredMode1 can be determined respectively, and the first intra prediction mode and the second intra prediction mode of the luma component of the current block can be obtained by looking up Table 1.

It should be noted that since the first version of AVS3 only supports 34 intra prediction modes, such as illustrated in FIG. 8, if the index starts from 0, the 34th mode is the PCM mode. More intra prediction modes are introduced in the second version of AVS3, expanding to 66 intra prediction modes, as illustrated in FIG. 10. In order to be compatible with the first version, an original decoding method for intra_luma_pred_mode is not changed in the second version. Instead, if intra_luma_pred_mode is greater than 1, another flag is introduced, namely eipm_pu_flag.

intra_luma_pred_mode
if (EipmEnableFlag && intra_luma_pred_mode > 1) {
eipm_pu_flag
}

eipm_pu_flag is anintra luma prediction mode extension flag, which is a binary variable. eipm_pu_flag with value “1” indicates that an intra angular prediction extension mode should be used, and eipm_pu_flag with value “0” indicates that the intra luma prediction extension mode is not used. The value of EipmPuFlag is equal to the value of eipm_pu_flag. If eipm_pu_flag does not exist in the bitstream, the value of EipmPuFlag is equal to 0.

Therefore, for a text description corresponding to the second version of AVS3, description of eipm_pu_flag, eipm_pu_flag0, eipm_pu_flag1 should be introduced into the above syntax intra_luma_pred_mode, intra_luma_pred_mode0, intra_luma_pred_mode1. IntraLumaPredMode0 is determined according to intra_luma_pred_mode0 and eipm_pu_flag0, and IntraLumaPredMode1 is determined according to intra_luma_pred_mode1 and eipm_pu_flag1.

At S904, a first prediction block is obtained by performing intra prediction on the luma component of the current block using the first intra prediction mode, and a second prediction block is obtained by performing intra prediction on the luma component of the current block using the second intra prediction mode.

St S905, the second weighting matrix is obtained according to derivation mode information of the second weighting matrix.

For example, the decoder executes the following program to obtain the second weighting matrix of the luma component of the current block.

```
stepIdx =(SawpIdx >> 3) − 3
modAngNum = AwpIdx % 8
if (modAngNum == 2) {
angleIdx = 7
}
else if (modAngNum == 6) {
angleIdx = 8
}
else {
angleIdx = modAngNum % 2
}
subAngleIdx = modAngNum >> 1
if (subAngleIdx == 0) {
  for (y=0; y<N; y++)
    for (x=0; x<M; x++) {
      AwpWeightArrayY[x][y] = ReferenceWeights[(y << 1) + ((x <<
1) >> angleIdx)]
    }
  }
}
if (subAngleIdx == 1) {
  for (y=0; y<N; y++)
    for (x=0; x<M; x++) {
      AwpWeightArrayY[x][y] = ReferenceWeights[(y << 1) − ((x <<
1) >> angleIdx)]
    }
  }
}
if (subAngleIdx == 2) {
  for (y=0; y<N; y++)
    for (x=0; x<M; x++) {
      AwpWeightArrayY[x][y] = ReferenceWeights[(x << 1) − ((y <<
1) >> angleIdx)]
    }
  }
}
if (subAngleIdx == 3) {
  for (y=0; y<N; y++)
    for (x=0; x<M; x++) {
      AwpWeightArrayY[x][y] = ReferenceWeights[(x << 1) + ((y <<
1) >> angleIdx)]
    }
  }
}
```

M represents a width of the current block, N represents a height of the current block, AwpWeightArrayY represents the second weighting matrix of the luma component Y. Reference weights ReferenceWeights[x] may be obtained according to the following program.

```
ValidLength_W = (M + (N >> angleIdx)) << 1
ValidLength_H = (N + (M >> angleIdx)) << 1
DeltaPos_W = stepIdx * ((ValidLength_W >> 3) − 1)
DeltaPos_H = stepIdx * ((ValidLength_H >> 3) − 1)
if (subAngleIdx == 0) {
  if (PhAwpRefineFlag == 0) {
    FirstPos = (ValidLength_H >> 1) − 6 + DeltaPos_H
    for (x=0; x<ValidLength_H; x++) {
      ReferenceWeights[x] = Clip3(0, 8, x − FirstPos)
    }
  }
  else {
    FirstPos = (ValidLength_H >> 1) − 3 + DeltaPos_H
    for (x=0; x<ValidLength_H; x++) {
      ReferenceWeights[x] = Clip3(0, 8, (x − FirstPos) << 1)
    }
  }
}
else if (subAngleIdx == 1) {
  if (PhAwpRefineFlag == 0) {
    FirstPos = (ValidLength_H >> 1) − 4 + DeltaPos_H − ((M << 1)
>> angleIdx)
    for (x=0; x<ValidLength_H; x++) {
      ReferenceWeights[x] = Clip3(0, 8, x − FirstPos)
    }
  }
  else {
    FirstPos = (ValidLength_H >> 1) − 1 + DeltaPos_H − ((M << 1)
>> angleIdx)
    for (x=0; x<ValidLength_H; x++) {
      ReferenceWeights[x] = Clip3(0, 8, (x − FirstPos) << 1
    }
  }
}
else if (subAngleIdx == 2) {
  if (PhAwpRefineFlag == 0) {
    FirstPos = (ValidLength_W >> 1) − 4 + DeltaPos_W − ((N << 1)
>> angleIdx)
    for (x=0; x<ValidLength_W; x++) {
      ReferenceWeights[x] = Clip3(0, 8, x − FirstPos)
    }
  }
  else {
    FirstPos = (ValidLength_W >> 1) − 1 + DeltaPos_W − ((N << 1)
>> angleIdx)
    for (x=0; x<ValidLength_W; x++) {
      ReferenceWeights[x] = Clip3(0, 8, (x − FirstPos) << 1)
    }
  }
}
else if (subAngleIdx == 3) {
  if (PhAwpRefineFlag == 0) {
    FirstPos = (ValidLength_W >> 1) − 6 + DeltaPos_W
    for (x=0; x<ValidLength_W; x++) {
      ReferenceWeights[x] = Clip3(0, 8, x − FirstPos)
    }
  }
  else {
    FirstPos = (ValidLength_W >> 1) − 3 + DeltaPos_W
    for (x=0; x<ValidLength_W; x++) {
      ReferenceWeights[x] = Clip3(0, 8, (x − FirstPos) << 1)
    }
  }
}
```

It should be noted that operations at S904 and S905 may be performed in any order.

At S906, a final prediction block of the luma component of the current block is obtained by weighting the first prediction block and the second prediction block of the luma component of the current block according to the second weighting matrix.

In an example, the final prediction block of the luma component of the current block is obtained according to the formula (4):

predMatrixSawpY[x][y]=(predMatrixY0[x][y]*AwpWeightArrayY[x][y]+predMatrixY1[x][y]*(8−AwpWeightArrayY[x][y])+4)<<3 (4)

where Y represents the luma component, predMatrixSawpY[x][y] represents a final prediction value of sample [x][y] in the luma component, predMatrixY0[x][y] represents a first prediction value of sample [x][y] in the first prediction block of the luma component of the current block, predMatrixY2[x][y] represents a second prediction value of sample [x][y] in the second prediction block of the luma component of the current block, AwpWeightArrayY[x][y] represents a weight value corresponding to predMatrixY0[x][y] in the second weighting matrix AwpWeightArrayY.

At S907, an initial intra prediction mode of the chroma component of the current block is determined. Specifically, if the initial intra prediction mode of the chroma component of the current block carried in the bitstream is not a derivation mode, the initial intra prediction mode of the chroma component of the current block carried in the bitstream will be used for intra prediction of the chroma component of the current block. If the initial intra prediction mode of the chroma component of the current block carried in the bitstream is the derivation mode, operations at S908 will be performed.

If the bitstream does not carry the mode information of the initial intra prediction mode of the chroma component of the current block, the initial intra prediction mode of the chroma component of the current block is default to the derivation mode, and operations at S908 will be performed.

In some implementations, the following process will be performed during determining the intra prediction mode IntraChromaPredMode of the chroma component of the current block.
1) If SawpFlag for the current block is 1 (indicating that the solution in the disclosure is used for the current block), isRedundant is equal to 0, and proceed to step 3). Otherwise, proceed to step 2).
2) If the luma prediction mode IntraLumaPredMode of a prediction block of the current block for which value of PredBlockOrder is 0 is equal to 0, 2, 12 or 24, then isRedundant is equal to 1. Otherwise, isRedundant is equal to 0.
3) If the value of tscpm_enable_flag is equal to “1” or the value of pmc_enable_flag is equal to “1”, and the value of intra_chroma_pred_mode is equal to “1”, then IntraChromaPredMode is equal to (5+IntraChromaEnhancedMode+3*IntraChromaPmcFlag).
4) otherwise,
   If the value of tscpm_enable_flag is equal to “1” and the value of intra_chroma_pred_mode is not equal to 0, then the value of intra_chroma_pred_mode is reduced by 1;
   If isRedundant is equal to 0, IntraChromaPredMode is equal to intra_chroma_pred_mode; otherwise, the following steps are performed in sequence:
      If IntraLumaPredMode is equal to 0, predIntraChromaPredMode is equal to 1; if IntraLumaPredMode is equal to 2, predIntraChromaPredMode is equal to 4; if IntraLumaPredMode is equal to 12, predIntraChromaPredMode is equal to 3; if IntraLumaPredMode is equal to 24, then predIntraChromaPredMode is equal to 2;
      If the value of intra_chroma_pred_mode is equal to 0, IntraChromaPredMode is equal to 0; otherwise, if the value of intra_chroma_pred_mode is less than predIntraChromaPredMode, IntraChromaPredMode is equal to intra_chroma_pred_mode; otherwise IntraChromaPredMode is equal to intra_chroma_pred_mode plus 1.
   a) According to the value of IntraChromaPredMode, look up Table 2 to obtain the intra prediction mode of the chroma component of the current block.

If SawpFlag of the current block is 1 and IntraChromaPredMode is equal to 0, the intra prediction mode of the chroma component of the current block is Intra_Chroma_DM instead of PCM.

In this disclosure, if at least two intra prediction modes are used for the first component of the current block to determine the prediction block, then intra prediction modes of a first component of a subsequent current block will not be redundant modes. During binarization of intra chroma prediction modes, there is no need to check and remove redundant modes, that is, the above step 2) does not need to be performed.

At S908, when the initial intra prediction mode of the chroma component of the current block is determined as the derivation mode, the first intra prediction mode and the second intra prediction mode of the luma component of the current block are determined as a first intra prediction mode and a second intra prediction mode of the chroma component of the current block.

At S909, a first weighting matrix is determined according to the second weighting matrix.

For example, if the number of samples contained in the luma component corresponding to the current block is equal to the number of samples contained in the chroma component of the current block, the second weighting matrix is assigned as the first weighting matrix. If the number of samples contained in the chroma component corresponding to the current block is less than the number of samples contained in the luma component of the current block, the first weighting matrix is obtained by downsampling the second weighting matrix.

For example, in case of YUV 4:2:0, the decoder executes the following program to obtain the first weighting matrix.

```
for (y=0; y<N/2; y++)
  for (x=0; x<M/2; x++) {
    AwpWeightArrayUV[x][y]=AwpWeightArrayY[x << 1][y << 1]
  }
}
```

AwpWeightArrayUV represents the first weighting matrix, and AwpWeightArrayY represents the second weighting matrix.

It should be noted that operations at S908 and S908 may be performed in any order.

At S910, a first prediction block of the chroma component of the current block is obtained by performing intra prediction on the chroma component of the current block using the first intra prediction mode, and a second prediction block of the chroma component of the current block is obtained by performing intra prediction on the chroma component of the current block using the second intra prediction mode.

At S911, a final prediction block of the chroma component of the current block is obtained by weighting the first prediction block and the second prediction block of the chroma component of the current block according to the first weighting matrix.

For example, the chroma component includes U component and V component. A final prediction block of U component of the current block may be determined according to formula (5):

predMatrixSawpU[x][y]=(predMatrixU0[x][y]*AwpWeightArrayUV[x][y]+predMatrixU1[x][y]*(8−AwpWeightArrayUV[x][y])+4)<<3 (5)

where predMatrixSawpU[x][y] represents a final prediction value of sample [x][y] in the U component, predMatrixU0[x][y] represents a first prediction value of sample [x][y] in the first prediction block of the U component of the current block, predMatrixU1[x][y] represents a second prediction value of sample [x][y] in the second prediction block of the U component of the current block, AwpWeightArrayUV[x][y] represents a weight value corresponding to predMatrixU0[x][y] in the first weighting matrix AwpWeightArrayUV.

A final prediction block of V component of the current block is obtained according to formula (6):

predMatrixSawpV[x][y]=(predMatrixV0[x][y]*AwpWeightArrayUV[x][y]+predMatrixV1[x][y]*(8−AwpWeightArrayUV[x][y]+4)<<3 (6)

where predMatrixSawpV[x][y] represents a final prediction value of sample [x][y] in the V component, predMatrixV0[x][y] represents a first prediction value of sample [x][y] in the first prediction block of the V component of the current block, predMatrixV1[x][y] represents a second prediction value of sample [x][y] in the second prediction block of the V component of the current block, AwpWeightArrayUV[x][y] represents a weight value corresponding to predMatrixV0[x][y] in the first weighting matrix AwpWeightArrayUV.

Finally, the decoder performs subsequent processing, including decoding of quantized coefficients, inverse transformation and inverse quantization to determine a residual block, combining the residual block and the prediction block into a reconstructed block, and subsequent loop filtering, etc.

It should be noted that FIG. 12 and FIG. 14 to FIG. 18 are only examples of the disclosure, which should not be construed as limitation to the disclosure.

The preferred implementations of the present disclosure have been described in detail above in conjunction with the accompanying drawings. However, the present disclosure is not limited to the specific details in the above implementations. Within the scope of the technical concept of the present disclosure, various simple modifications may be made to the technical solutions of the present disclosure. These simple modifications all belong to the protection scope of the present disclosure. For example, the various specific technical features described in the above specific implementation manners can be combined in any suitable manner if there is no contradiction. As another example, any combination of various implementations of the present disclosure can also be made, as long as they do not violate the idea of the present disclosure, which should also be regarded as the content disclosed in the present disclosure.

It should also be understood that in the various method implementations of the present disclosure, the sequence numbers of the above-mentioned processes do not mean the order of execution, and the order of execution of the processes should be determined by their functions and internal logic, and should not be used in this disclosure. The implementation of the examples constitutes no limitation. In addition, in the implementation of the present disclosure, the term “and/or” is only an association relationship describing associated objects, indicating that there may be three relationships. Specifically, A and/or B may mean A exists alone, A and B exist simultaneously, and B exists alone. In addition, the character “/” in this article generally indicates that the contextual objects are an “or” relationship.

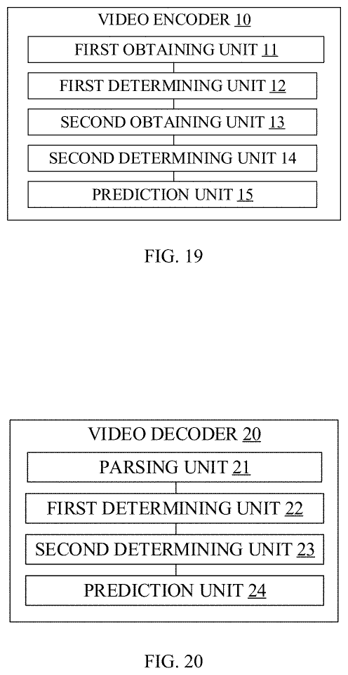

The method implementations in the disclosure are described in detailed above with reference to FIG. 14 to FIG. 18. In the following, apparatus implementations of the disclosure will be described in detailed with reference to FIG. 19 to FIG. 21.

FIG. 19 is a schematic diagram of a video encoder 10 provided in implementations of the disclosure.

As illustrated in FIG. 19, the video encoder 10 includes a first obtaining unit 11, a first determining unit 12, a second obtaining unit 13, a second determining unit 14, and a prediction unit 15.

The first obtaining unit 11 is configured to obtain a current block, where the current block includes a first component.

The first determining unit 12 is configured to determine an initial intra prediction mode of the first component of the current block.

The second obtaining unit 13 is configured to obtain, when the initial intra prediction mode is a derivation mode, at least two intra prediction modes of a second component corresponding to the current block.

The second determining unit 14 is configured to determine an intra prediction mode of the first component of the current block according to the at least two intra prediction modes of the second component.

The prediction unit 15 is configured to obtain a final prediction block of the first component of the current block by performing intra prediction on the first component of the current block using the intra prediction mode of the first component of the current block.

In some implementations, the intra prediction mode of the first component of the current block includes at least two intra prediction modes.

In an example, the second determining unit 14 is specifically configured to assign the at least two intra prediction modes of the second component as the intra prediction mode of the first component of the current block.

In an example, the second determining unit 14 is specifically configured to derive the intra prediction mode of the first component of the current block according to the at least two intra prediction modes of the second component.

In this case, the prediction unit 15 is specifically configured to obtain, for each of the at least two intra prediction modes of the first component of the current block, a prediction block corresponding the intra prediction mode by performing intra prediction on the first component of the current block using the intra prediction mode, and obtain the final prediction block of the first component of the current block according to the prediction blocks corresponding to the intra prediction modes.

In some implementations, the prediction unit 15 is specifically configured to determine a first weighting matrix, and obtain the final prediction block of the first component of the current block by weighting the prediction blocks corresponding to the intra prediction modes according to the first weighting matrix.

In some implementations, the prediction unit 15 is specifically configured to derive the first weighting matrix according to a weighting-matrix derivation mode.

In some implementations, the prediction unit 15 is specifically configured to obtain a second weighting matrix of the second component corresponding to the current block, assign the second weighting matrix as the first weighting matrix if a number of samples contained in the second component corresponding to the current block is equal to a number of samples contained in the first component of the current block, and obtain the first weighting matrix by downsampling the second weighting matrix if the number of samples contained in the first component of the current block is less than the number of samples contained in the second component corresponding to the current block.

In some implementations, the prediction unit 15 is specifically configured to obtain the first weighting matrix by downsampling the second weighting matrix according to the number of samples contained in the first component of the current block and the number of samples contained in the second component corresponding to the current block.

Optionally, the second weighting matrix contains at least two different weight values.

Optionally, all weight values in the second weighting matrix are the same.

Optionally, for each sample corresponding to a weight value in the second weighting matrix, a prediction value of the sample in the second component is obtained by predicting using the at least two intra prediction modes of the second component.

Optionally, the at least two intra prediction modes of the second component include N intra prediction modes, N is a positive integer greater than or equal to 2, and the second weighting matrix contains N types of different weight values, where i-th type of weight value indicates that a prediction value of a sample in the second component corresponding to the i-th type of weight value is obtained from only the i-th intra prediction mode, and i is a positive integer greater than or equal to 2 and less than or equal to N.

Optionally, the at least two intra prediction modes of the second component include a first intra prediction mode and a second intra prediction mode, and the second weighting matrix contains a maximum weight value, a minimum weight value, and at least one middle weight value. The maximum weight value indicates that a prediction value of a corresponding sample in the second component is obtained by predicting using only the first intra prediction mode. The minimum weight value indicates that a prediction value of a corresponding sample in the second component is obtained by predicting using only the second intra prediction mode. The middle weight value indicates that a prediction value of a corresponding sample in the second component is obtained by predicting using both the first intra prediction mode and the second intra prediction mode.

Optionally, the second weighting matrix contains multiple types of weight values, and locations where the weight values change forms a straight line or curve.

Optionally, the second weighting matrix is a weighting matrix corresponding to an AWP mode or a GPM mode.

In some implementations, the intra prediction mode of the first component of the current block includes one intra prediction mode.

In an example, the second determining unit 14 is specifically configured to assign one of the at least two intra prediction modes of the second component as the intra prediction mode of the first component of the current block.

In an example, the second determining unit 14 is specifically configured to determine the intra prediction mode of the first component of the current block according to an intra prediction mode of the second component corresponding to a first sample location of the current block.

In an example, the second determining unit 14 is specifically configured to assign one intra prediction mode as the intra prediction mode of the first component of the current block, if a prediction value of the second component corresponding to the first sample location is obtained by predicting using only the one intra prediction mode, and assign an intra prediction mode with a maximum weight value among multiple intra prediction modes as the intra prediction mode of the first component of the current block, if the prediction value of the second component corresponding to the first sample location is obtained by predicting using the multiple intra prediction modes.

In an example, the second determining unit 14 is specifically configured to assign an intra prediction mode of the second component stored in a minimum unit corresponding to the first sample location as the intra prediction mode of the first component of the current block.

Optionally, if the prediction value of the second component corresponding to the first sample location is obtained by predicting using only the one intra prediction mode, mode information of one intra prediction mode is stored in the minimum unit. If the prediction value of the second component corresponding to the first sample location is obtained by predicting using the plurality of intra prediction modes, mode information of an intra prediction mode with a maximum weight value among a plurality of intra prediction modes is stored in the minimum unit.

In some implementations, the first component includes a first sub-component and a second sub-component. In this case, the prediction unit 15 is specifically configured to obtain, for each of the at least two intra prediction modes of the first component of the current block, a prediction block of the first sub-component corresponding to the intra prediction mode by performing intra prediction on the first sub-component of the current block using the intra prediction mode, and obtain, for each of the at least two intra prediction modes of the first component of the current block, a prediction block of the second sub-component corresponding to the intra prediction mode by performing intra prediction on the second sub-component of the current block using the intra prediction mode.

In an example, the prediction unit 15 is specifically configured to obtain a final prediction block of the first sub-component of the current block by weighting the prediction blocks of the first sub-component corresponding to the intra prediction modes according to the first weighting matrix, and obtain a final prediction block of the second sub-component of the current block by weighting the prediction blocks of the second sub-component corresponding to the intra prediction modes according to the first weighting matrix.

In an example, the prediction unit 15 is specifically configured to obtain the final prediction block of the first sub-component of the current block according to the following formula:

predMatrixSawpA[x][y]=(predMatrixA0[x][y]*AwpWeightArrayAB[x][y]+predMatrixA1[x][y]*(2ⁿ−AwpWeightArrayAB[x][y]+2ⁿ⁻¹)<<n
where A represents the first sub-component, predMatrixSawpA[x][y] represents a final prediction value of sample [x][y] in the first sub-component, predMatrixA0[x][y] represents a first prediction value of sample [x][y] in a first prediction block of the first sub-component of the current block, predMatrixA1[x][y] represents a second prediction value of sample [x][y] in a second prediction block of the first sub-component of the current block, AwpWeightArrayAB [x][y] represents a weight value of predMatrixA0[x][y] in the first weighting matrix AwpWeightArrayAB, 2ⁿ is a preset sum of weights, and n is a positive integer.

In an example, the prediction unit 15 is specifically configured to obtain the final prediction block of the second sub-component of the current block according to the following formula:

predMatrixSawpB[x][y]=(predMatrixB0[x][y]*AwpWeightArrayAB[x][y]+predMatrixB1[x][y]*(2ⁿ−AwpWeightArrayAB[x][y]+2ⁿ⁻¹)<<n
where B represents the second sub-component, predMatrixSawpB[x][y] represents a final prediction value of sample [x][y] in the second sub-component, predMatrixB0[x][y] represents a first prediction value of sample [x][y] in a first prediction block of the second sub-component of the current block, predMatrixB1[x][y] represents a second prediction value of sample [x][y] in a second prediction block of the second sub-component of the current block, AwpWeightArrayAB[x][y] represents a weight value of predMatrixB0[x][y] in the first weighting matrix AwpWeightArrayAB, 2ⁿ is a preset sum of weights, and n is a positive integer.

In an example, the prediction unit 15 is further configured to generate a bitstream, where the bitstream includes a weighted-prediction flag, and the weighted-prediction flag indicates whether a prediction block of the second component is obtained by predicting using the at least two intra prediction modes

In some implementations, the first determining unit 12 is specifically configured to determine the initial intra prediction mode of the first component of the current block as the derivation mode if the at least two intra prediction modes are used for prediction of the second component.

In some implementations, the bitstream further includes mode information of the at least two intra prediction modes of the second component.

In some implementations, the bitstream further includes derivation mode information of the second weighting matrix.

In some implementations, the current block has a size satisfying a preset condition.

The preset condition includes one or more of the following:
Condition 1, a width of the current block is greater than or equal to a first preset width TH1, and a height of the current block is greater than or equal to a first preset height TH2.
Condition 2, a number of samples in the current block is greater than or equal to a first preset number TH3.
Condition 3, the width of the current block is less than or equal to a second preset width TH4, and the height of the current block is greater than or equal to a second preset height TH5.
Condition 4, a width-length ratio of the current block is a first preset ratio.
Condition 5, the size of the current block is a second preset value; or
Condition 6, the height of the current block is greater than or equal to a third preset height, the width of the current block is greater than or equal to a third preset width, a width-height ratio of the current block is less than or equal to a third preset value, and a height-width ratio of the current block is less than or equal to the third preset value.

Optionally, the first preset ratio is any of 1:1, 2:1, 1:2, 1:4, and 4:1.

Optionally, the second preset value is one of 16×32, 32×32, 16×64, and 64×16.

Optionally, the first component is a chroma component, and the second component is a luma component.

Optionally, the chroma component includes a U component and a V component, and the first sub-component is the U component, and the second sub-component is the V component.

It should be understood that the apparatus implementations and the method implementations may correspond to each other, and similar descriptions may refer to the method implementations. To avoid repetition, details are not repeated here. Specifically, the video encoder 10 illustrated in FIG. 19 can execute the method in implementations of the present disclosure, and the aforementioned and other operations and/or functions of each unit in the video encoder 10 are configured to implement methods 400, 500, and 600, etc. For the sake of brevity, the corresponding processes are not repeated herein.

FIG. 20 is a schematic diagram of a video decoder 20 provided in implementations of the disclosure.

As illustrated in FIG. 20, the video decoder 20 may include a parsing unit 21, a first determining unit 22, a second determining unit 23, and a prediction unit 24.

The parsing unit 21 is configured to parse a bitstream to obtain a current block and at least two intra prediction modes of a second component corresponding to the current block, where the current block includes a first component.

The first determining unit 22 is configured to determine an initial intra prediction mode of the first component of the current block.

The second determining unit 23 is configured to determine, when the initial intra prediction mode is determined as a derivation mode, an intra prediction mode of the first component of the current block according to at least two intra prediction modes of the second component.

The prediction unit 24 is configured to obtain a final prediction block of the first component of the current block by performing intra prediction on the first component of the current block using the intra prediction mode of the first component of the current block.

In some implementations, the bitstream carries a weighted-prediction flag, where the weighted-prediction flag indicates whether a prediction block of the second component is obtained by predicting using the at least two intra prediction modes.

Optionally, the bitstream carries mode information of the initial intra prediction mode of the first component of the current block.

The first determining unit 22 is further configured to determine the initial intra prediction mode of the first component of the current block as the derivation mode, when the bitstream carries the weighted-prediction flag and does not carry mode information of the initial intra prediction mode of the first component of the current block.

In some implementations, the intra prediction mode of the first component of the current block includes at least two intra prediction modes.

In an example, the second determining unit 23 is specifically configured to assign the at least two intra prediction modes of the second component as the intra prediction mode of the first component of the current block.

In an example, the second determining unit 23 is specifically configured to derive the intra prediction mode of the first component of the current block according to the at least two intra prediction modes of the second component.

In this case, the prediction unit 24 is specifically configured to obtain, for each of the at least two intra prediction modes of the first component of the current block, a prediction block corresponding the intra prediction mode by performing intra prediction on the first component of the current block using the intra prediction mode, and determine the final prediction block of the first component of the current block according to the prediction blocks corresponding to the intra prediction modes.

In some implementations, the prediction unit 24 is specifically configured to determine a first weighting matrix, and obtain the final prediction block of the first component of the current block by weighting the prediction blocks corresponding to the intra prediction modes according to the first weighting matrix.

In some implementations, the prediction unit 24 is specifically configured to derive the first weighting matrix according to a weighting-matrix derivation mode.

In some implementations, the prediction unit 24 is specifically configured to obtain a second weighting matrix of the second component corresponding to the current block, assign the second weighting matrix as the first weighting matrix if a number of samples contained in the second component corresponding to the current block is equal to a number of samples contained in the first component of the current block, and obtain the first weighting matrix by downsampling the second weighting matrix if the number of samples contained in the first component of the current block is less than the number of samples contained in the second component corresponding to the current block.

In some implementations, the prediction unit 24 is specifically configured to obtain derivation mode information of the second weighting matrix from the bitstream, and obtain the second weighting matrix according to the derivation mode information of the second weighting matrix.

In some implementations, the prediction unit 24 is specifically configured to obtain the first weighting matrix by downsampling the second weighting matrix according to the number of samples contained in the first component of the current block and the number of samples contained in the second component corresponding to the current block.

Optionally, the second weighting matrix contains at least two different weight values.

Optionally, all weight values in the second weighting matrix are the same.

Optionally, for each sample corresponding to a weight value in the second weighting matrix, a prediction value of the sample in the second component is obtained by predicting using the at least two intra prediction modes of the second component.

Optionally, the at least two intra prediction modes of the second component comprises N intra prediction modes, N is a positive integer greater than or equal to 2, and the second weighting matrix contains N types of different weight values, wherein i-th type of weight value indicates that a prediction value of a sample in the second component corresponding to the i-th type of weight value is obtained from only the i-th intra prediction mode, and i is a positive integer greater than or equal to 2 and less than or equal to N.

Optionally, the at least two intra prediction modes of the second component comprise a first intra prediction mode and a second intra prediction mode, and the second weighting matrix contains a maximum weight value, a minimum weight value, and at least one middle weight value, where the maximum weight value indicates that a prediction value of a corresponding sample in the second component is obtained by predicting using only the first intra prediction mode, the minimum weight value indicates that a prediction value of a corresponding sample in the second component is obtained by predicting using only the second intra prediction mode, and the middle weight value indicates that a prediction value of a corresponding sample in the second component is obtained by predicting using both the first intra prediction mode and the second intra prediction mode.

Optionally, the second weighting matrix contains a plurality of types of weight values, and locations where the weight values change forms a straight line or curve.

Optionally, the second weighting matrix is a weighting matrix corresponding to an AWP mode or a GPM mode.

In some implementations, the intra prediction mode of the first component of the current block includes one intra prediction mode.

In an example, the second determining unit 23 is specifically configured to assign one of the at least two intra prediction modes of the second component as the intra prediction mode of the first component of the current block.

In an example, the second determining unit 23 is specifically configured to determine the intra prediction mode of the first component of the current block according to an intra prediction mode of the second component corresponding to a first sample location of the current block.

In an example, the second determining unit 23 is specifically configured to assign one intra prediction mode as the intra prediction mode of the first component of the current block if a prediction value of the second component corresponding to the first sample location is obtained by predicting using only the one intra prediction mode, and assign an intra prediction mode with a maximum weight value among a plurality of intra prediction modes as the intra prediction mode of the first component of the current block if the prediction value of the second component corresponding to the first sample location is obtained by predicting using the plurality of intra prediction modes.

In an example, the second determining unit 23 is specifically configured to assign an intra prediction mode of the second component stored in a minimum unit corresponding to the first sample location as the intra prediction mode of the first component of the current block.

Optionally, if the prediction value of the second component corresponding to the first sample location is obtained by predicting using only the one intra prediction mode, mode information of one intra prediction mode is stored in the minimum unit, and if the prediction value of the second component corresponding to the first sample location is obtained by predicting using the plurality of intra prediction modes, mode information of an intra prediction mode with a maximum weight value among a plurality of intra prediction modes is stored in the minimum unit.

In some implementations, the first component comprises a first sub-component and a second sub-component, and the prediction unit 24 is specifically configured to obtain, for each of the at least two intra prediction modes of the first component of the current block, a prediction block of the first sub-component corresponding to the intra prediction mode, by performing intra prediction on the first sub-component of the current block using the intra prediction mode, and obtain, for each of the at least two intra prediction modes of the first component of the current block, a prediction block of the second sub-component corresponding to the intra prediction mode, by performing intra prediction on the second sub-component of the current block using the intra prediction mode.

In some implementations, the prediction unit 24 is specifically configured to obtain a final prediction block of the first sub-component of the current block, by weighting the prediction blocks of the first sub-component corresponding to the intra prediction modes according to the first weighting matrix, and obtain a final prediction block of the second sub-component of the current block by weighting the prediction blocks of the second sub-component corresponding to the intra prediction modes according to the first weighting matrix.

In some implementations, the prediction unit 24 is specifically configured to obtain the final prediction block of the first sub-component of the current block according to the following formula:

predMatrixSawpA[x][y]=(predMatrixA0[x][y]*AwpWeightArrayAB[x][y]+predMatrixA1[x][y]*(2ⁿ−AwpWeightArrayAB[x][y]+2ⁿ⁻¹)<<n
where A represents the first sub-component, predMatrixSawpA[x][y] represents a final prediction value of sample [x][y] in the first sub-component, predMatrixA0[x][y] represents a first prediction value of sample [x][y] in a first prediction block of the first sub-component of the current block, predMatrixA1[x][y] represents a second prediction value of sample [x][y] in a second prediction block of the first sub-component of the current block, AwpWeightArrayAB [x][y] represents a weight value of predMatrixA0[x][y] in the first weighting matrix AwpWeightArrayAB, 2ⁿ is a preset sum of weights, and n is a positive integer.

In an example, the prediction unit 24 is specifically configured to obtain the final prediction block of the second sub-component of the current block according to the following formula:

predMatrixSawpB[x][y]=(predMatrixB0[x][y]*AwpWeightArrayAB[x][y]+predMatrixB1[x][y]*(2ⁿ−AwpWeightArrayAB[x][y]+2ⁿ⁻¹)<<n
where B represents the second sub-component, predMatrixSawpB[x][y] represents a final prediction value of sample [x][y] in the second sub-component, predMatrixB0[x][y] represents a first prediction value of sample [x][y] in a first prediction block of the second sub-component of the current block, predMatrixB1[x][y] represents a second prediction value of sample [x][y] in a second prediction block of the second sub-component of the current block, AwpWeightArrayAB[x][y] represents a weight value of predMatrixB0[x][y] in the first weighting matrix AwpWeightArrayAB, 2ⁿ is a preset sum of weights, and n is a positive integer.

In some implementations, the current block has a size satisfying a preset condition.

The preset condition includes one or more of the following:
Condition 1, a width of the current block is greater than or equal to a first preset width TH1, and a height of the current block is greater than or equal to a first preset height TH2.
Condition 2, a number of samples in the current block is greater than or equal to a first preset number TH3.
Condition 3, the width of the current block is less than or equal to a second preset width TH4, and the height of the current block is greater than or equal to a second preset height TH5.
Condition 4, a width-height ratio of the current block is a first preset ratio.
Condition 5, the size of the current block is a second preset value; or
Condition 6, the height of the current block is greater than or equal to a third preset height, the width of the current block is greater than or equal to a third preset width, a width-height ratio of the current block is less than or equal to a third preset value, and a height-width ratio of the current block is less than or equal to the third preset value.

Optionally, the first preset ratio is any of 1:1, 2:1, 1:2, 1:4, and 4:1.

Optionally, the second preset value is one of 16×32, 32×32, 16×64, and 64×16.

Optionally, the first component is a chroma component, and the second component is a luma component.

Optionally, the chroma component includes a U component and a V component, and the first sub-component is the U component, and the second sub-component is the V component.

It should be understood that the apparatus implementations and the method implementations may correspond to each other, and similar descriptions may refer to the method implementations. To avoid repetition, details are not repeated here. Specifically, the video encoder 10 illustrated in FIG. 19 can execute the method 700, 800, or 900 in implementations of the present disclosure, and the aforementioned and other operations and/or functions of each unit in the video encoder 10 are configured to implement methods 700, 800, and 900, etc. For the sake of brevity, the corresponding processes are not repeated herein.

The apparatus and system of the implementations of the present disclosure are described above from the perspective of functional units with reference to the accompanying drawings. It should be understood that the functional units may be implemented in the form of hardware, may also be implemented by instructions in the form of software, and may also be implemented by a combination of hardware and software units. Specifically, each step of the method implementations in the disclosure can be completed by an integrated logic circuit of the hardware in the processor and/or instructions in the form of software, and the steps of the method disclosed in implementations of the disclosure can be directly executed by a hardware coding processor or a combination of hardware and software units in the decoding processor. Optionally, the software unit may be located in a mature storage medium in the field such as random access memory, flash memory, read-only memory, programmable read-only memory, electrically erasable programmable memory, and registers. The storage medium is located in the memory, and the processor reads the information from the memory, and completes the steps in the above method implementations in combination with its hardware.

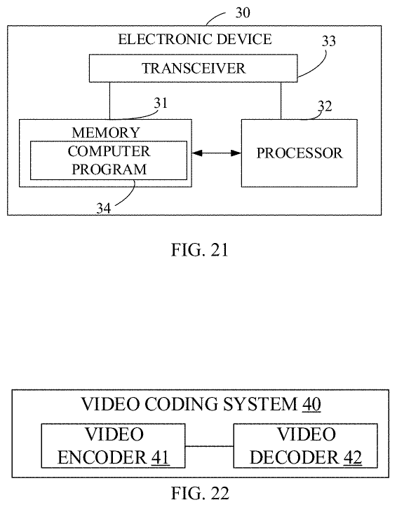

FIG. 21 is a schematic block diagram of an electronic device 30 provided in implementations of the present disclosure.

As illustrated in FIG. 21, the electronic device 30 may be the video encoder or video decoder described in implementations of the present disclosure. The electronic device 30 may include a memory 31 and a processor 32.

The memory 31 is used to store a computer program 34 and transmit the program code 34 to the processor 32. In other words, the processor 32 can call and run the computer program 34 from the memory 31 to implement the method in implementations of the present disclosure.

For example, the processor 32 can be used to execute the steps in the above-mentioned method 200 according to the instructions in the computer program 34.

In some implementations of the present disclosure, the processor 32 may include, but is not limited to: general-purpose processor, digital signal processor (DSP), disclosure specific integrated circuit (ASIC), field programmable gate array (FPGA) or other programmable logic devices, discrete gates or transistor logic devices, discrete hardware components, and so on.

In some implementations of the present disclosure, the memory 31 includes but is not limited to: volatile memory and/or non-volatile memory. The non-volatile memory can be read-only memory (ROM), programmable read-only memory (PROM), erasable programmable read-only memory (EPROM), electrically programmable Erase Programmable Read-Only Memory (EEPROM) or Flash. The volatile memory may be Random Access Memory (RAM), which acts as an external cache. By way of illustration and not limitation, many forms of RAM are available such as Static RAM (SRAM), Dynamic RAM (DRAM), Synchronous DRAM (Synchronous DRAM, SDRAM), double data rate synchronous dynamic random access memory (Double Data Rate SDRAM, DDR SDRAM), enhanced synchronous dynamic random access memory (Enhanced SDRAM, ESDRAM), synchronous connection dynamic random access memory (synch link DRAM, SLDRAM) and Direct Memory Bus Random Access Memory (Direct Rambus RAM, DR RAM).

In some implementations of the present disclosure, the computer program 34 can be divided into one or more units, and the one or more units are stored in the memory 31 and executed by the processor 32 to complete the methods in the present disclosure. The one or more units may be a series of computer program instruction segments capable of accomplishing specific functions, and the instruction segments are used to describe the execution process of the computer program 34 in the electronic device 30.

As illustrated in FIG. 21, the electronic device 30 may also include: a transceiver 33, where the transceiver 33 may be connected to the processor 32 or the memory 31.

The processor 32 can control the transceiver 33 to communicate with other devices, specifically, to send information or data to other devices, or receive information or data sent by other devices. The transceiver 33 may include a transmitter and a receiver. The transceiver 33 may further include antennas, and the number of antennas may be one or more.

It should be understood that the various components in the electronic device 30 are connected through a bus system, where the bus system includes not only a data bus, but also a power bus, a control bus and a status signal bus.

FIG. 22 is a schematic block diagram of a video coding system 40 provided in implementation of the present disclosure.

As illustrated in FIG. 22, the video coding system 40 may include a video encoder 41 and a video decoder 42, where the video encoder 41 is used to execute the video encoding method involved in implementations of the present disclosure, and the video decoder 42 is used to execute the video decoding method involved in implementations of the present disclosure.

The present disclosure also provides a computer storage medium, on which a computer program is stored, and when the computer program is executed by a computer, the computer can execute the methods of the above method implementations. In other words, the implementations of the present disclosure further provide a computer program product including instructions, and when the instructions are executed by a computer, the computer executes the methods of the foregoing method implementations.

When implemented using software, the disclosure may be implemented in whole or in part in the form of a computer program product. The computer program product includes one or more computer instructions. When the computer program instructions are loaded and executed on the computer, the processes or functions according to the implementations of the present disclosure will be generated in whole or in part. The computer can be a general purpose computer, a special purpose computer, a computer network, or other programmable device. The computer instructions may be stored in or transmitted from one computer-readable storage medium to another computer-readable storage medium, for example, the computer instructions may be transferred from a website, computer, server, or data center by wire (such as coaxial cable, optical fiber, digital subscriber line (DSL)) or wireless (such as infrared, wireless, microwave, etc.) to another website site, computer, server or data center. The computer-readable storage medium may be any available medium that can be accessed by a computer, or a data storage device such as a server or a data center integrated with one or more available media. The available medium may be a magnetic medium (such as a floppy disk, a hard disk, or a magnetic tape), an optical medium (such as a digital video disc (DVD)), or a semiconductor medium (such as a solid state disk (SSD)), etc.

Those skilled in the art can appreciate that the units and algorithm steps of the examples described in conjunction with the implementations disclosed herein can be implemented by electronic hardware, or a combination of computer software and electronic hardware. Whether these functions are executed by hardware or software depends on the specific disclosure and design constraints of the technical solution. Those skilled in the art may use different methods to implement the described functions for each specific disclosure, but such implementation should not be regarded as exceeding the scope of the present disclosure.

In the several implementations provided in this disclosure, it should be understood that the disclosed systems, apparatuses, and methods may be implemented in other ways. For example, the apparatus implementations described above are only illustrative. For example, the division of the units is only a logical function division. In actual implementation, there may be other division methods. For example, multiple units or components can be combined or can be integrated into another system, or some features may be ignored, or not implemented. In another point, the mutual coupling or direct coupling or communication connection illustrated or discussed may be through some interfaces, and the indirect coupling or communication connection of devices or units may be in electrical, mechanical or other forms.

A unit described as a separate component may or may not be physically separated, and a component displayed as a unit may or may not be a physical unit, that is, it may be located in one place, or may be distributed to multiple network units. Part or all of the units can be selected according to actual needs to achieve the purpose of the solution of this implementation. For example, each functional unit in each implementation of the present disclosure may be integrated into one processing unit, each unit may exist separately physically, or two or more units may be integrated into one unit.

The above is only a specific implementation of the disclosure, but the scope of protection of the disclosure is not limited thereto. Those skilled in the art can easily think of changes or substitutions within the technical scope disclosed in the disclosure, which should be covered within the scope of protection of this disclosure. Therefore, the protection scope of the present disclosure should be based on the protection scope of the claims.

What is claimed is:

1. A method for video encoding, comprising:
obtaining a current block, the current block comprising a first component;
determining an initial intra prediction mode of the first component of the current block;
when the initial intra prediction mode is a derivation mode, obtaining at least two intra prediction modes of a second component corresponding to the current block;
determining an intra prediction mode of the first component of the current block according to the at least two intra prediction modes of the second component; and
obtaining a final prediction block of the first component of the current block by performing intra prediction on the first component of the current block using the intra prediction mode of the first component of the current block.

2. The method of claim 1, wherein the intra prediction mode of the first component of the current block comprises at least two intra prediction modes, and determining the intra prediction mode of the first component of the current block according to the at least two intra prediction modes of the second component comprises:
assigning the at least two intra prediction modes of the second component as the intra prediction mode of the first component of the current block; or
deriving the intra prediction mode of the first component of the current block according to the at least two intra prediction modes of the second component.

3. The method of claim 2, wherein obtaining the final prediction block of the first component of the current block by performing intra prediction on the first component of the current block using the intra prediction mode of the first component of the current block comprises:
for each of the at least two intra prediction modes of the first component of the current block, obtaining a prediction block corresponding the intra prediction mode by performing intra prediction on the first component of the current block using the intra prediction mode;
determining a first weighting matrix; and
obtaining the final prediction block of the first component of the current block by weighting the prediction blocks corresponding to the intra prediction modes according to the first weighting matrix.

4. The method of claim 1, wherein the intra prediction mode of the first component of the current block comprises one intra prediction mode.

5. The method of claim 4, wherein determining the intra prediction mode of the first component of the current block according to the at least two intra prediction modes of the second component comprises:
assigning one of the at least two intra prediction modes of the second component as the intra prediction mode of the first component of the current block; or
determining the intra prediction mode of the first component of the current block according to an intra prediction mode of the second component corresponding to a first sample location of the current block.

6. The method of claim 5, wherein determining the intra prediction mode of the first component of the current block according to the intra prediction mode of the second component corresponding to the first sample location of the current block comprises:
assigning one intra prediction mode as the intra prediction mode of the first component of the current block, if a prediction value of the second component corresponding to the first sample location is obtained by predicting using only the one intra prediction mode; and
assigning an intra prediction mode with a maximum weight value among a plurality of intra prediction modes as the intra prediction mode of the first component of the current block, if the prediction value of the second component corresponding to the first sample location is obtained by predicting using the plurality of intra prediction modes.

7. The method of claim 5, wherein determining the intra prediction mode of the first component of the current block according to the intra prediction mode of the second component corresponding to the first sample location of the current block comprises:
assigning an intra prediction mode of the second component stored in a minimum unit corresponding to the first sample location as the intra prediction mode of the first component of the current block.

8. A method for video decoding, comprising:
parsing a bitstream to obtain a current block and at least two intra prediction modes of a second component corresponding to the current block, the current block comprising a first component;
determining an initial intra prediction mode of the first component of the current block;
when the initial intra prediction mode is determined as a derivation mode, determining an intra prediction mode of the first component of the current block according to the at least two intra prediction modes of the second component; and
obtaining a final prediction block of the first component of the current block by performing intra prediction on the first component of the current block using the intra prediction mode of the first component of the current block.

9. The method of claim 8, wherein the bitstream carries a weighted-prediction flag, wherein the weighted-prediction flag indicates whether a prediction block of the second component is obtained by predicting using the at least two intra prediction modes.

10. The method of claim 9, wherein the bitstream carries mode information of the initial intra prediction mode of the first component of the current block.

11. The method of claim 9, wherein determining the initial intra prediction mode of the first component of the current block comprises:
determining the initial intra prediction mode of the first component of the current block as the derivation mode, when the bitstream carries the weighted-prediction flag and does not carry mode information of the initial intra prediction mode of the first component of the current block.

12. The method of claim 8, wherein the intra prediction mode of the first component of the current block comprises at least two intra prediction modes.

13. The method of claim 12, wherein determining the intra prediction mode of the first component of the current block according to the at least two intra prediction modes of the second component comprises:
assigning the at least two intra prediction modes of the second component as the intra prediction mode of the first component of the current block; or
deriving the intra prediction mode of the first component of the current block according to the at least two intra prediction modes of the second component.

14. The method of claim 12, wherein performing intra prediction on the first component of the current block using the intra prediction mode of the first component of the current block comprises:
for each of the at least two intra prediction modes of the first component of the current block, obtaining a prediction block corresponding the intra prediction mode by performing intra prediction on the first component of the current block using the intra prediction mode;
determining a first weighting matrix; and
obtaining the final prediction block of the first component of the current block by weighting the prediction blocks corresponding to the intra prediction modes according to the first weighting matrix.

15. The method of claim 8, wherein the intra prediction mode of the first component of the current block comprises one intra prediction mode.

16. The method of claim 15, wherein determining the intra prediction mode of the first component of the current block according to the at least two intra prediction modes of the second component comprises:
assigning one of the at least two intra prediction modes of the second component as the intra prediction mode of the first component of the current block.

17. The method of claim 15, wherein determining the intra prediction mode of the first component of the current block according to the at least two intra prediction modes of the second component comprises:
determining the intra prediction mode of the first component of the current block according to an intra prediction mode of the second component corresponding to a first sample location of the current block.

18. The method of claim 17, wherein determining the intra prediction mode of the first component of the current block according to the intra prediction mode of the second component corresponding to the first sample location of the current block comprises:
assigning one intra prediction mode as the intra prediction mode of the first component of the current block, if a prediction value of the second component corresponding to the first sample location is obtained by predicting using only the one intra prediction mode; and
assigning an intra prediction mode with a maximum weight value among a plurality of intra prediction modes as the intra prediction mode of the first component of the current block, if the prediction value of the second component corresponding to the first sample location is obtained by predicting using the plurality of intra prediction modes.

19. The method of claim 18, wherein determining the intra prediction mode of the first component of the current block according to the intra prediction mode of the second component corresponding to the first sample location of the current block comprises:
assigning an intra prediction mode of the second component stored in a minimum unit corresponding to the first sample location as the intra prediction mode of the first component of the current block.

20. A video decoder, comprising a processor and a memory storing a computer program which, when executed by the processor, causes the processor to:
parse a bitstream to obtain a current block and at least two intra prediction modes of a second component corresponding to the current block, the current block comprising a first component;
determine an initial intra prediction mode of the first component of the current block;
determine, when the initial intra prediction mode is determined as a derivation mode, an intra prediction mode of the first component of the current block according to at least two intra prediction modes of the second component; and
obtain a final prediction block of the first component of the current block by performing intra prediction on the first component of the current block using the intra prediction mode of the first component of the current block.
